(19) United States
(12) Patent Application Publication
(10) Pub. No.: US 2021/0406822 A1
(43) Pub. Date: Dec. 30, 2021

(54) INFORMATION PROCESSING DEVICE, INFORMATION PROCESSING SYSTEM, AND INFORMATION PROCESSING METHOD, AND PROGRAM

(71) Applicant: SONY GROUP CORPORATION, Tokyo (JP)

(72) Inventor: Mikio NAKAI, Tokyo (JP)

(73) Assignee: Sony Group Corporation, Tokyo (JP)

(21) Appl. No.: 17/293,449

(22) PCT Filed: Oct. 23, 2019
(86) PCT No.: PCT/JP2019/041484

§ 371 Date: May 12, 2021

(30) Foreign Application Priority Data
Nov. 21, 2018 (JP) 2018-218123

(51) Int. Cl. G06Q 10/08; G06N 7/00

(52) U.S. Cl. CPC G06Q 10/0838; G06N 7/005; G06Q 10/0832; G06Q 10/0833

(57) ABSTRACT

An information processing device includes a data processing unit including a processor in communication with a storage unit configured to store instructions that, when executed by the processor, cause the processor to determine data indicative of an estimation of whether or not there is a person in a residence for performing a delivery process, including determining the data based on external characteristic information of an outside of the residence.

### CROSS REFERENCE TO RELATED APPLICATIONS

This application claims the benefit of Japanese Priority Patent Application JP 2018-218123 filed on Nov. 21, 2018, the entire contents of which are incorporated herein by reference.

### TECHNICAL FIELD

The present disclosure relates to an information processing device, an information processing system, and an information processing method, and a program. More specifically, the present disclosure relates to, for example, an information processing device, an information processing system, and an information processing method, and a program that perform a package delivery process.

### BACKGROUND ART

In recent years, development of self-propelled robots and automobiles has been actively conducted. For example, it has been proposed to use a self-propelled robot for package delivery processing.

However, in a case of delivering a package, there is a problem that the package may not be delivered if a resident of the delivery destination is not at home.

Note that, PTL 1 (JP 2013-170050A) discloses a configuration in which a delivery schedule is generated on the basis of delivery result data and the like of a delivery destination to enhance delivery efficiency. However, this patent literature only discloses a configuration of generating a delivery schedule in a case where a person delivers a package, but not a delivery process using a robot.

### CITATION LIST

### Patent Literature

### PTL 1: JP 2013-170050A

### SUMMARY

### Technical Problem

In the present disclosure, it is desirable to provide an information processing device, an information processing system, and an information processing method, and a program that realize efficient package delivery, in a case of delivering a package, by calculating at-home probability of each residence on the basis of analysis data of surrounding circumstances or delivery result data of a residence as a destination of delivery by an autonomous traveling robot, and determining a delivery process or a delivery route corresponding to the calculated probability.

### Solution to Problem

A first aspect of the present disclosure is a data processing unit including a processor in communication with a storage unit configured to store instructions that, when executed by the processor, cause the processor to determine data indicative of an estimation of whether or not there is a person in a residence for performing a delivery process, including determining the data based on external characteristic information of an outside of the residence.

Moreover, a second aspect of the present disclosure is an information processing system including a mobile device and a management server, in which

a sensor of the mobile device acquires external characteristic information of an outside of a residence and transmits the information to the management server, and

the management server includes a processor in communication with a storage unit configured to store instructions that, when executed by the processor, cause the processor to determine data indicative of an estimation of whether or not there is a person in the residence for performing a delivery process, including determining the data based on the external characteristic information.

Furthermore, a third aspect of the present disclosure is

an information processing method executed in an information processing device including a data processing unit including a processor in communication with a storage unit configured to store instructions that, when executed by the processor, cause the processor to determine data indicative of an estimation of whether or not there is a person in a residence for performing a delivery process, the method including

determining, by the data processing unit, the data based on external characteristic information of an outside of the residence.

Moreover, a fourth aspect of the present disclosure is

an information processing method executed in an information processing system including a mobile device and a management server, the method including:

acquiring, by a sensor of the mobile device, external characteristic information of an outside of a residence and transmitting the information to the management server, and

determining, by the management server, data indicative of an estimation of whether or not there is a person in the residence for performing a delivery process including determining the data based on the external characteristic information.

Moreover, a fifth aspect of the present disclosure is

a non-transitory computer readable medium including instructions that, when executed by a processor, cause the processor to determine data indicative of an estimation of whether or not there is a person in a residence for performing a delivery process including determining the data based on external characteristic information of an outside of the residence.

Here, the program of the present disclosure is, for example, a program that can be provided by a storage medium or communication medium that provides various program codes in a computer-readable format to an information processing device or computer system capable of executing the program codes. By providing such a program in a computer readable format, processing according to the program can be realized in the information processing device or the computer system.

Other objects, features, and advantages of the present disclosure will become apparent from the more detailed description based on the embodiments of the present disclosure described later and the attached drawings. In addition, in this specification, a system is a logical set configuration of a plurality of devices, and the device of each configuration is not limited to be those in a same housing.

### Advantageous Effects of Invention

According to the configuration of an embodiment of the present disclosure, a configuration is realized in which a sensor of a mobile device acquires external characteristic information that can be observed from outside of the residence, and at-home estimation of whether or not there is a person in the residence is performed.

More specifically, for example, a data processing unit is included to perform the at-home estimation of whether or not there is a person in the residence. The data processing unit performs the at-home estimation based on at-home probability data calculated on the basis of the external characteristic information that can be observed from outside of the residence. The at-home probability data is data that varies according to date and time, and the at-home probability corresponding to the current date and time is calculated from the at-home probability data. The data processing unit performs a process of comparing at-home estimation rules and external characteristic information, which differ according to residence types, to calculate the at-home probability. The information processing device is a mobile device capable of autonomous traveling, and a sensor of the mobile device acquires external characteristic information that can be observed from outside of the residence.

This configuration realizes a configuration that the sensor of the mobile device acquires external characteristic information that can be observed from outside of the residence and at-home estimation of whether or not there is a person in the residence is performed.

Note that, the effects described in this specification are examples and should not be limited and there may be other additional effects.

### BRIEF DESCRIPTION OF DRAWINGS

FIG. 1 is a diagram for explaining an outline of a process executed by a mobile device according to an embodiment of the present disclosure.

FIG. 2 is a diagram for explaining a configuration example of a communication system of the mobile device.

FIG. 3 is a diagram for explaining an example of at-home probability data of each residence used to determine a delivery route or a travel route of the mobile device.

FIG. 4 is a diagram for explaining an example of information (appearance characteristics) applied to calculation of the at-home probability.

FIG. 5 is a diagram for explaining an example of “at-home estimation rule” applied in a case where the residence is an apartment.

FIG. 6 is a diagram for explaining an example of the “at-home-estimation rule” applied in a case where the residence is a detached house.

FIG. 7 is a diagram for explaining an example of one-day at-home probability data of a special day when the at-home probability decreases (the year-end and New Year holidays, etc.).

FIG. 8 is a diagram for explaining an example of one-day at-home probability data of a special day when the at-home probability increases (the television audience rating high event (the Olympics, etc.) is held, or the like).

FIG. 9 is a diagram for explaining a process sequentially performed at time of a periodical delivery process performed by the mobile device.

FIG. 10 is a diagram for explaining an example of data update of at-home probability data by a learning process.

FIG. 11 is a diagram for explaining an example of data update of at-home probability data by the learning process.

FIG. 12 is a diagram illustrating a flowchart for explaining a sequence of a process executed by the mobile device.

FIG. 13 is a diagram for explaining an outline of a process according to a second embodiment.

FIG. 14 is a diagram for explaining a specific delivery process example to which the process according to the second embodiment is applied.

FIG. 15 is a diagram illustrating a flowchart for explaining a sequence of a process performed by the mobile device according to the second embodiment.

FIG. 16 is a diagram for explaining an outline of a process according to a third embodiment.

FIG. 17 is a diagram illustrating an example of a process for generating and updating at-home probability data.

FIG. 18 is a diagram for explaining a specific delivery process example to which the process according to the third embodiment is applied.

FIG. 19 is a diagram illustrating a flowchart for explaining a learning process sequence in an at-home estimation unit.

FIG. 20 is a diagram illustrating a flowchart for explaining a process sequence for calculating the at-home probability.

FIG. 21 is a diagram illustrating a flowchart for explaining a process sequence of determining a delivery route based on the at-home probability.

FIG. 22 is a diagram for explaining a configuration example of the mobile device.

FIG. 23 is a diagram for explaining a configuration example of the mobile device.

FIG. 24 is a diagram for explaining a configuration example of a management server.

### DESCRIPTION OF EMBODIMENTS

In the following, details of an information processing device, an information processing system, and an information processing method, and a program according to embodiments of the present disclosure will be described with reference to the drawings. Note that, the description will be given according to the following items.

1. Outline of processing performed by mobile device according to the embodiment of the present disclosure

2. (First embodiment) Calculation and update process of at-home probability data based on comparison between residence observation information and at-home estimation rule

3. (Second embodiment) Process to perform at-home/absence estimation based on success or failure of delivery

4. (Third embodiment) Process to perform at-home/absence estimation based on success or failure of delivery while performing calculation and update processes of at-home probability data based on a comparison between observation information of residence and at-home estimation rules (First and Second embodiments)

5. Configuration example of mobile device

6. Hardware configuration example of another device

7. Summary of configuration according to the embodiments of the present disclosure

### 1. Outline of Processing Performed by Mobile Device According to the Embodiment of the Present Disclosure

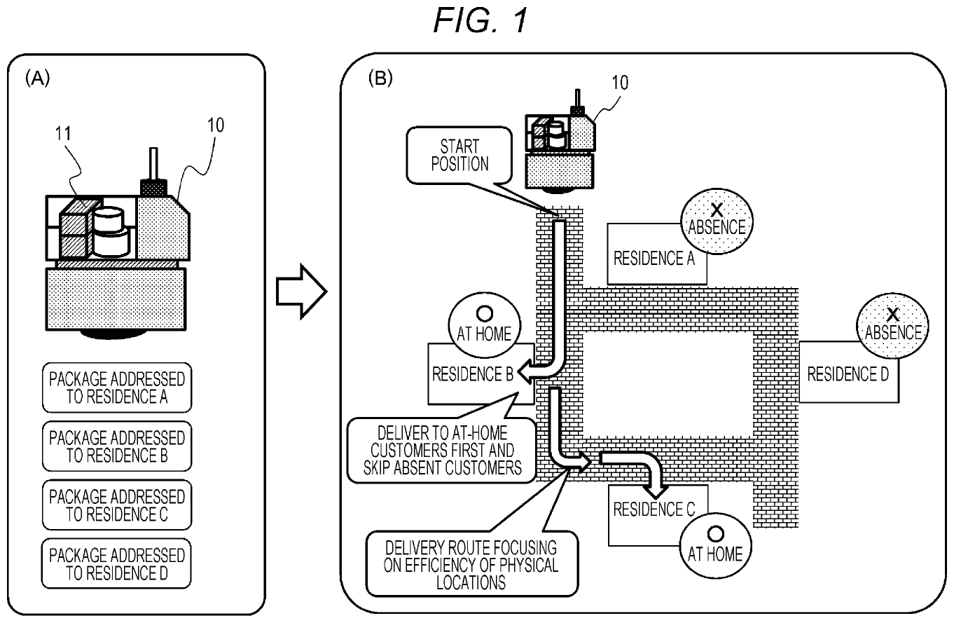

First, an outline of processing executed by a mobile device which is an information processing device according to the embodiment of the present disclosure will be described with reference to FIG. 1.
The mobile device according to the embodiment of the present disclosure is a self-propelled mobile device that delivers a package to each home in an area where there are many residences, such as an apartment or a residential area, for example. For example, at an entrance of an apartment, a delivery company unloads, from a truck, a plurality of packages to be delivered to each residence of the apartment, transships the packages to a loading platform of a mobile device, and sequentially delivers the packages to delivery destinations.

Here, the delivery destination is not limited to the apartment and may be an area where there are many residences, such as an area of many detached houses. In this case, delivery processing is performed by sequentially routing delivery destinations selected from a plurality of houses in a predetermined area.

An example of processing performed by the mobile device 10 according to the embodiment of the present disclosure will be described with reference to FIG. 1.

As illustrated in FIG. 1(A), in the mobile device 10, a plurality of packages 11 to be delivered is loaded on a loading platform in advance.

As illustrated in FIG. 1(A), the plurality of packages 11 loaded on the loading platform is packages, which are delivered to residences in a travel area of the mobile device 10. In other words, the following four packages are loaded:

a package addressed to residence A,

a package addressed to residence B,

a package addressed to residence C, and

a package addressed to residence D.

Here, the mobile device 10 performs a delivery process as illustrated in FIG. 1(B).

The mobile device 10 firstly acquires at-home probability data of each residence in a moving area from a memory in the mobile device 10 or a management server that can communicate with the mobile device 10.

The at-home probability of each residence is calculated on the basis of surrounding circumstances of the residence analyzed on the basis of information acquired by a sensor such as a camera mounted on the mobile device 10, and a past delivery results. A specific example of this process will be described later.

Next, the mobile device 10 determines a delivery route of the packages on the basis of the acquired at-home probability data of each residence.

Finally, the mobile device 10 delivers the packages according to the package delivery route determined on the basis of the at-home probability data of each residence.

The example of delivery illustrated in FIG. 1(B) is an example of estimating that residents of residences A and D may be absent and that residents of residences B and C may be at home, on the basis of the acquired at-home probability data of each residence.

The mobile device 10 determines, on the basis of the estimation result, a delivery route to delivery destinations including residences B and C, which are estimated that the residents may be at home, and executes the delivery process according to the determined delivery route.
As illustrated in FIG. 1(B), the mobile device 10 starts traveling from a start position, delivers a “package addressed to residence B” to residence B, which is estimated that the resident may be at home, and then proceeds to residence C, which is estimated that the resident may be at home, to deliver a “package addressed to residence C” to residence C.

At this time, package delivery to residences A and D, which are estimated that the residents may be absent, is not performed.

The package delivery to residences A and D, which are estimated that the residents may be absent, will be performed, for example, at date and time when the at-home probability is estimated to be high on the basis of the at-home probability data.

As described above, the mobile device according to the embodiment of the present disclosure performs the delivery process by determining the delivery route on the basis of the at-home probability data of each residence generated in advance.

By performing such a process, the packages can be efficiently delivered without performing unnecessary traveling or delivering.

Note that, there may be a configuration that the mobile device 10 stores data necessary for the processes performed by the mobile device 10 in a storage unit in the mobile device and a control unit (data processing unit) in the mobile device 10 controls all processes including calculation of the at-home probability, delivery route determination, and the like, or there may be a configuration that a part of the processes may be performed by a management server 20 that can communicate with the mobile device 10. In other words, the management server 20 is also an example of the information processing device according to the embodiment of the present disclosure.

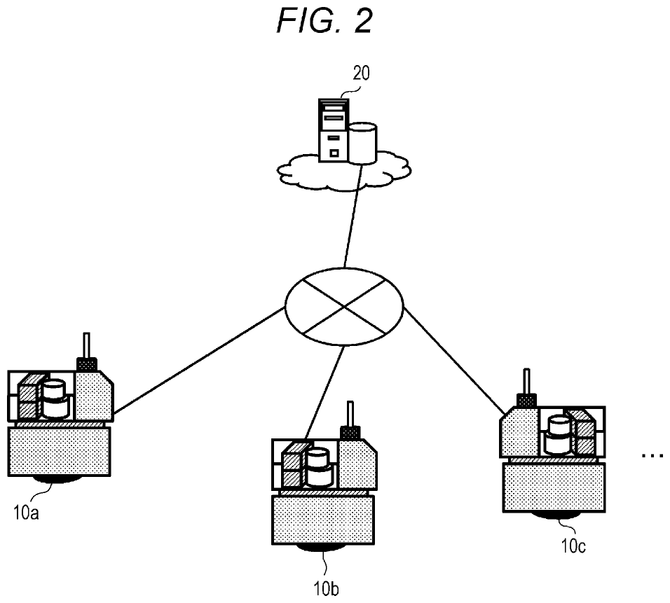

For example, as illustrated in FIG. 2, the management server 20 communicates with a plurality of mobile devices 10, and receives data from the mobile devices 10, which is, for example, current location information of the mobile devices or images captured by cameras provided in the mobile devices.

The management server 20 executes data processing such as calculation of the at-home probability of each residence, determination of a delivery route, and the like, using the above described information, and transmits the determined delivery route to each mobile device 10.

The mobile device 10 performs a delivery process according to the route determined by the management server 20.

The mobile device 10 and the management server 20 may jointly perform the data processing in this manner.

Note that, in a case where the mobile device 10 and the management server 20 jointly perform data processing, various settings can be made.

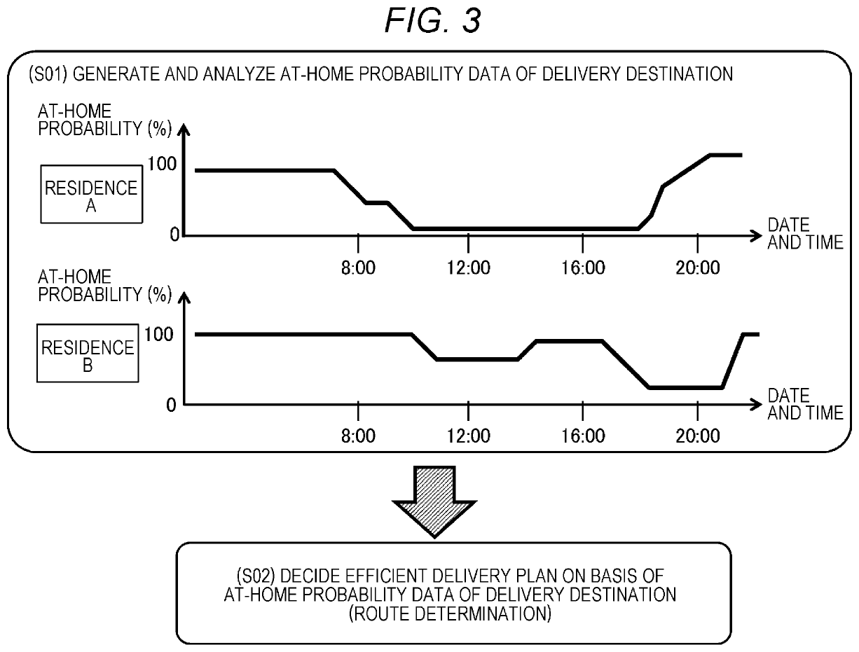

Next, with reference to FIG. 3, an example of the at-home probability data of each residence used to determine the delivery route and the travel route of the mobile device 10 will be described.

FIG. 3 (S01) illustrates an example of data of two delivery destination of residences A and B as an example of the at-home probability data of delivery destination.

The horizontal axis of each graph represents time, and the vertical axis represents at-home probability (%). Both graphs illustrate one-day at-home probability data.

As illustrated in FIG. 3 (S02), the mobile device 10 determines the package delivery route on the basis of the at-home probability data of each residence illustrated in FIG. 3 (S01), and delivers the package according to the determined package delivery route.

Note that the at-home probability data illustrated in FIG. 3 can be generated as data of various units such as one type of data in units of one day, seven types of data in units of day of week, individual pieces of data of one year or 365 days, and the like, for example. The at-home probability data is generated and updated sequentially by a learning process based on surrounding circumstances of the residence analyzed by acquired information of a sensor such as a camera mounted on the mobile device 10 or past delivery results.

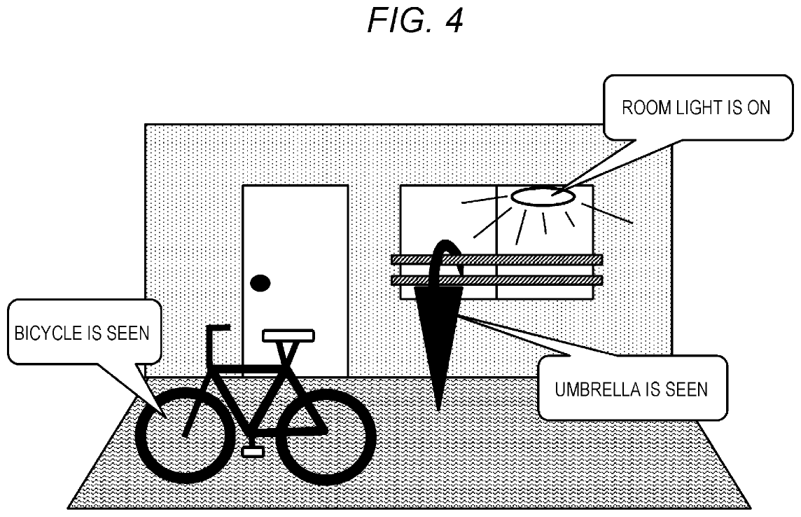

An example of information (appearance characteristics) applied to the calculation of the at-home probability will be described with reference to FIG. 4.

FIG. 4 illustrates following three types of information as an example of information (appearance characteristics) applicable to the calculation of the at-home probability.

(a) Room light

(b) Bicycle

(c) Umbrella

For example, (a) in a case where the room light is on, it can be estimated as “the resident is at home” and, in a case where the light is off, it can be estimated as “the resident is absent”,

(b) in a case where a bicycle is seen, it can be estimated as “the resident is at home” and, in a case where no bicycle is seen, it can be estimated as “the resident is absent”, and

(c) in a case where the umbrella is seen, it can be estimated as “the resident is at home” and, in a case where no umbrella is seen, it can be estimated as “the resident is absent”.

Note that these pieces of information (appearance characteristics) are information for at-home estimation associated with each residence, and the mobile device 10 or the management server 20 executes a learning process based on these appearance characteristics, and generates and updates the at-home probability data described above with reference to FIG. 3 on the basis of the accumulated learning data.

In addition, appearance characteristic information, which is surrounding circumstances of each residence, is acquired by a sensor such as a camera mounted in the mobile device 10, and the learning process based on the acquired data is continuously executed. The at-home probability data corresponding to each residence is sequentially updated by the learning process.

In a case where the learning process is executed to generate and update the at-home probability data, “at-home estimation rules” for estimating whether the resident of each residence is at home or not is defined in advance and stored in the storage unit, and the learning process is executed by using the rules.

The “at-home estimation rules” vary depending on a type of the destination residence, which is an apartment, a detached house, or the like, for example.

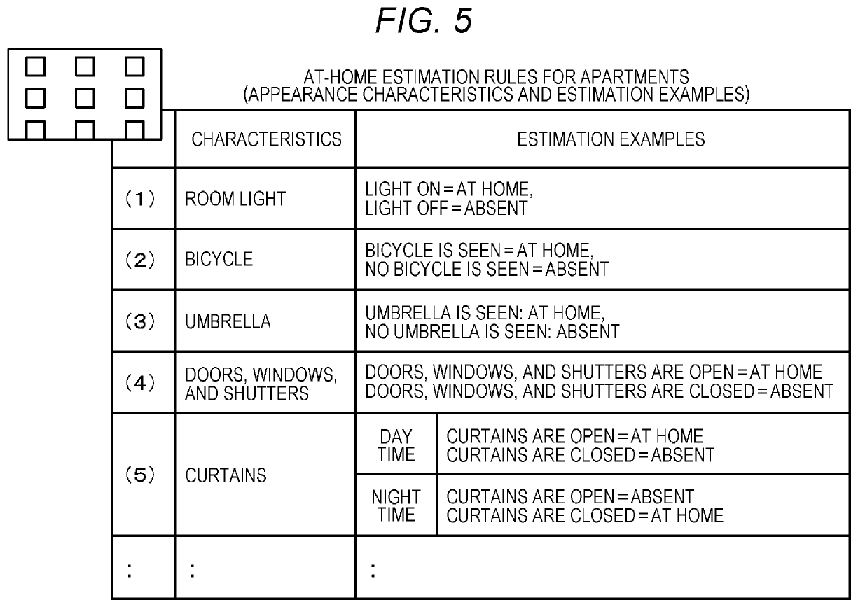

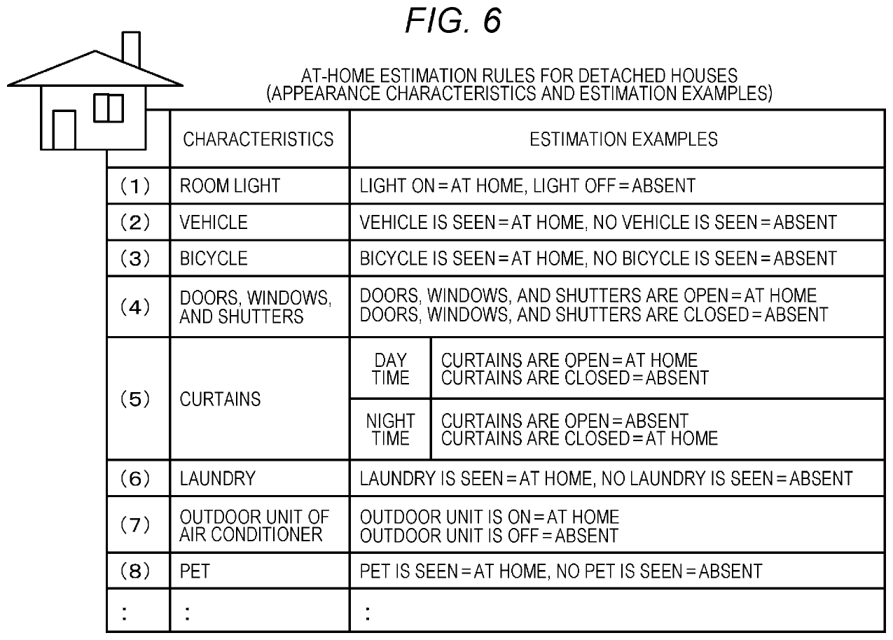

With reference to FIGS. 5 and 6, examples of the “at-home estimation rules” applied according to a residence type, which is an apartment or a detached house will be described.

FIG. 5 is a diagram illustrating an example of the “at-home estimation rules” applied in a case where the residence is an apartment. The appearance characteristics applicable to the “at-home estimation rule” applied in a case where the residence is an apartment are, for example, the following characteristics.

(1) Room light

(2) Bicycle

(3) Umbrella

(4) Doors, windows, and shutters

(5) Curtains

Here, in a case where the residence type is a condominium, an apartment, and the like, the estimation rules are applied to each unit.

For example, (1) in a case where the room light is on, it is estimated as “the resident is at home” and, in a case where the light is off, it is estimated as “the resident is absent”,

(2) in a case where a bicycle is seen, it is estimated as “the resident is at home” and, in a case where no bicycle is seen, it is estimated as “the resident is absent”,

(3) in a case where an umbrella is seen, it is presumed as “the resident is at home” and, in a case where no umbrella is seen, it is estimated as “the resident is absent”,

(4) in a case where any one of the doors, windows, and shutters is open, it is estimated as “the resident is at home” and, in a case where the doors, windows, and shutters are closed, it is estimated as “the resident is absent”, and

(5) regarding the curtains, it is estimated differently between daytime and nighttime. In daytime, in a case where the curtains are open, it is estimated as “the resident is at home” and, in a case where the curtains are closed, it is estimated as “the resident is absent”. On the other hand, in nighttime, in a case where the curtains are open, it is estimated as “the resident is absent” and, in a case where the curtains are closed, it is estimated as “the resident is at home”.

Next, with reference to FIG. 6, an example of the “at-home estimation rules” applied in a case where the residence is a detached house will be described. The appearance characteristics applicable to the “at-home estimation rules” applied in a case where the residence is a detached house include, for example, the following characteristics.

(1) Room light

(2) Bicycle

(3) Umbrella

(4) Doors, windows, and shutters

(5) Curtains

(6) Laundry

(7) Air conditioner outdoor unit

(8) Pet

The estimation examples of the characteristics (1) to (5) are similar to in the case of the apartment described with reference to FIG. 5.

(6) Regarding laundry, in a case where laundry is hung outside, it is estimated as “the resident is at home” and, in a case where no laundry is seen, it is estimated as “the resident is absent”.

(7) Regarding the air-conditioner outdoor unit, in a case where the air-conditioner outdoor unit is being driven, it is estimated as “the resident is at home” and, in a case where the outdoor unit is not driven, it is estimated as “the resident is absent”.

(8) Regarding pets, in a case where a pet is seen, it is estimated as “the resident is at home” and, in a case where no pet is seen, it is estimated as “the resident is absent”.

The mobile device 10 sequentially acquires various appearance characteristic information illustrated in FIGS. 5 and 6 to perform the learning process in which the above estimation rules are applied. For example, at the time of a delivery process to be executed every day, appearance characteristic information is acquired by using a sensor such as a camera, a microphone, and the like as passing by each residence.

The acquired information here is used as learning processing data.

Here, in FIGS. 5 and 6, the types of residence are described to be only two types, which are apartments and detached houses; however, there may be a configuration that different estimation rules are set according to various types of residents such as family apartments, luxurious apartments, studio apartments, single-person apartments, urban detached houses, suburban detached houses, mansions, and the like, in addition to the above.

Furthermore, it is preferable that the estimation rule is configured to perform different estimation depending on time zones for some characteristics, as described in the example of the curtains. In addition, different estimation processes may be performed depending on seasons, such as the year-end and New Year holidays, the consecutive holidays, during an events such as the Olympics, and the like.

Here, the at-home probability data calculated and updated by applying different rules according to the season is also different data according to the season.

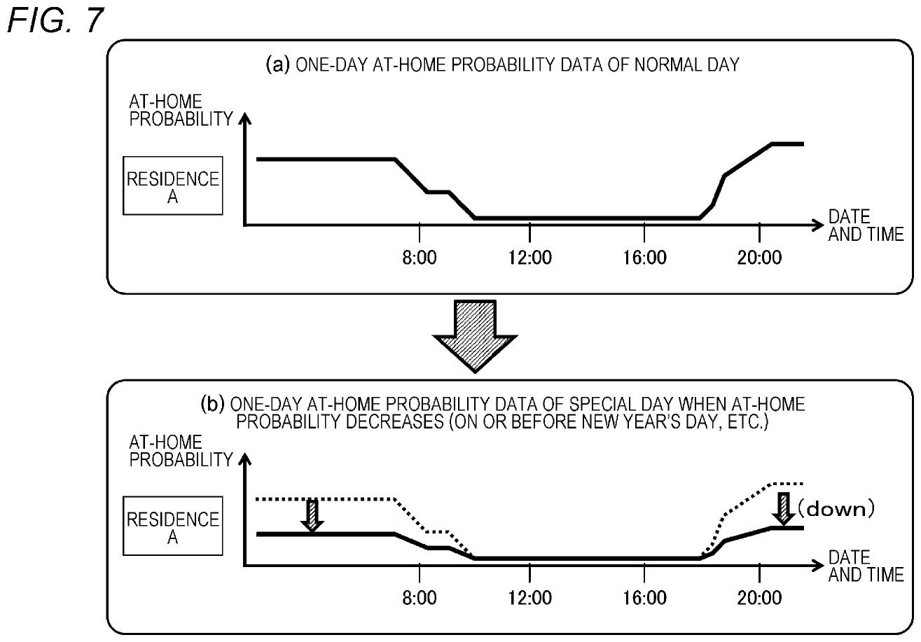

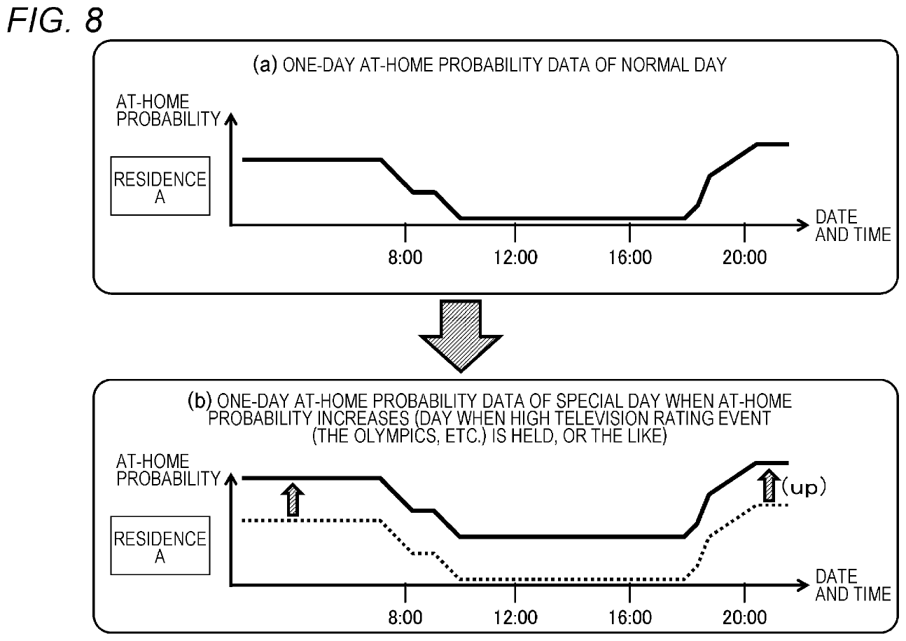

A specific example will be described with reference to FIGS. 7 and 8.

FIG. 7 illustrates following two pieces of at-home probability data regarding a same residence (residence A).

(a) One-day at-home probability data of normal day

(b) One-day at-home probability data of special day when at-home probability data decreases (the year-end and New Year holidays, etc.)

As can be seen by comparing the graphs (a) and (b) in FIG. 7, the at-home probability is decreased in (b) one-day at-home probability data of special day when at-home probability data decreases (the year-end and New Year holidays, etc.) compared to (a) one-day at-home probability data of normal day.

Furthermore, FIG. 8 also illustrates following two pieces of at-home probability data regarding the same residence (residence A).

(a) One-day at-home probability data of normal day

(b) One-day at-home probability data of special day when at-home probability increases (day when high television rating event (the Olympics, etc.) is held, or the like)

As can be seen by comparing the graphs of (a) and (b) in FIG. 8, the at-home probability is increased in (b) one-day at-home probability data of special day when at-home probability increases, compared to (a) one-day at-home probability data of normal day.

Thus, even for the same residence (residence A), different data is used as the at-home probability data depending on the situation of each day.

The mobile device 10 acquires at-home probability data corresponding to the current date and time, and performs a process of estimating the at-home probability on the basis of the acquired data.

### 2. (First Embodiment) Calculation and Update Process of at-Home Probability Data Based on Comparison Between Residence Observation Information and at-Home Estimation Rule

Next, as a first embodiment of the present disclosure, a processing example will be described in which at-home probability data is calculated and updated on the basis of comparison between residence observation information and the at-home estimation rules.

The mobile device 10 acquires residence observation information, which is the appearance characteristics, on the delivery route by a sensor such as a camera, a microphone, or the like provided in the mobile device 10, during a delivery process executed almost daily within a defined area. The learning process based on the acquired information is executed to generate and update the at-home probability data corresponding to each residence.

As described above, in the learning process for generating and updating the at-home probability data corresponding to each residence, a process using the “at-home estimation rules” for estimating whether a resident of each residence is at home or not.

The “at-home estimation rules” vary depending on a type of the destination residence, which is an apartment, a detached house, or the like, for example.

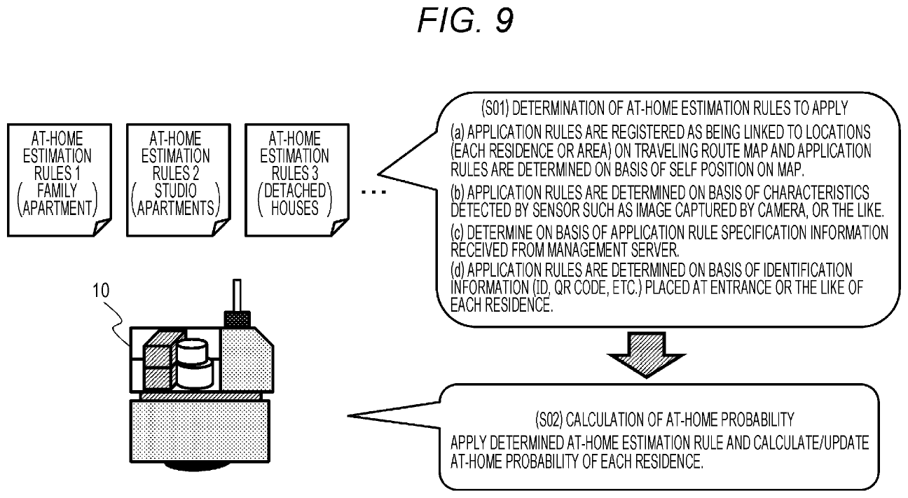

FIG. 9 is a diagram for explaining a process sequentially executed at time of the periodical delivery process performed by the mobile device 10.

In a case of performing the delivery process, the mobile device 10 executes a process of step S01 illustrated in FIG. 9. More specifically, the following process is performed.

(Step S01)

In step S01, the mobile device 10 firstly determines an at-home estimation rule to be applied. This application rule determination process is performed, for example, by any one of following (a) to (d).

(a) The application rules are registered as being linked to locations (each residence or area) on the traveling route map and the application rules are determined on the basis of self position on the map.

(b) The application rules are determined on the basis of characteristics detected by a sensor such as an image captured by a camera, or the like.

(c) Determination is made on the basis of application rule specification information received from the management server.

(d) The application rules are determined on the basis of identification information (ID, QR code, etc.) placed at an entrance or the like of each residence.

As described above, different at-home estimation rules are generated in advance depending on the residence type, specifically, for example, various residence types such as family apartments, luxurious apartments, studio apartments, single-person apartments, urban detached houses, suburban detached houses, mansions, and the like, and the at-home estimation rules corresponding to each residence type are stored in the storage unit of the mobile device 10 or the storage unit of the management server 20.

The mobile device 10 selects one rule to use in the current traveling process from various at-home estimation rules corresponding to the residence type, which is generated in advance.

As the process for this selection, any one of the processes (a) to (d) is performed.

(Step S02)

In a case where one at-home estimation rule is selected in step S01, in the next step S02, the mobile device 10 uses a sensor such as a camera or a microphone mounted in mobile device 10 to acquire surrounding circumstance information (appearance characteristics) of each residence and compares the acquired information with the registered information of the at-home estimation rule to newly calculate the at-home probability of each residence or update the data if there is already generated at-home probability data.

The mobile device 10 compares the information acquired using the sensor such as a camera, a microphone, or the like with the registered information of the at-home estimation rule, and continuously performs a learning process of generating or updating the at-home probability data of each residence in every traveling.

With this learning process, the at-home probability data of each residence is successively updated. Here, the updated at-home probability data of each residence is stored in the storage unit of the mobile device 10 or the storage unit of the management server 20. In other words, the mobile device 10 may typically perform at-home estimation of each residence by using the latest at-home probability data.

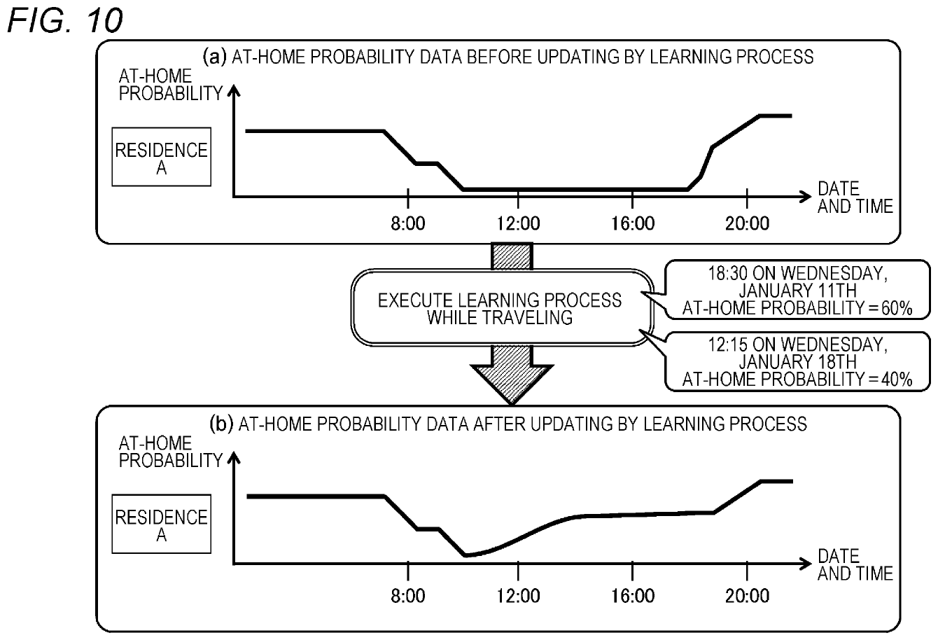

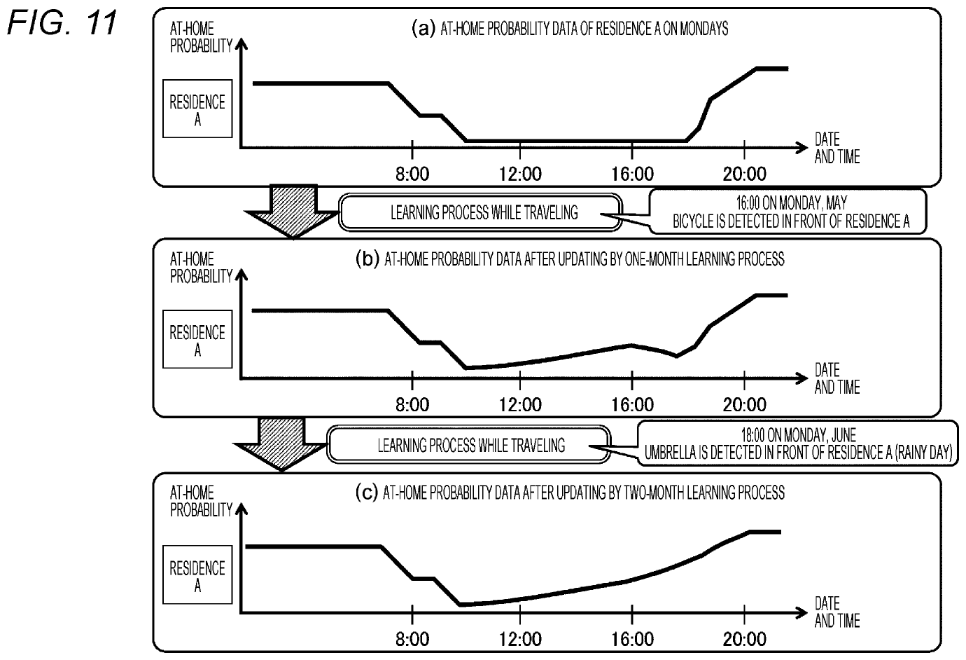

An example of data update of the at-home probability data by the learning process will be described with reference to FIGS. 10 and 11.

FIG. 10 illustrates following two pieces of at-home probability data regarding the same residence (residence A).

(a) At-home probability data before updating by learning process

(b) At-home probability data after updating by learning processing

FIG. 10(a) illustrates at-home probability data before updating by the learning process for the residence A, after this data is generated, the mobile device 10 repeats the traveling process of passing in front of the residence A for a plurality of times in a predetermined period of time, and the mobile device 10 executes a learning process of calculating at-home probability data of each residence by comparing information acquired using a sensor such as a camera, a microphone, or the like with registered information of the at-home estimation rules. The data updated as a result of the learning process for the predetermined period is the data illustrated in FIG. 10(b).

In the period of the learning process within the predetermined period, the mobile device 10 acquires, for example, following at-home probability calculation data.

At-home probability=60% at 18:30 on Wednesday, January 11th
At-home probability=40% at 12:15 on Wednesday, January 18th
These pieces of at-home probability calculation data are data calculated by the mobile device 10 comparing information acquired by using a sensor such as a camera, a microphone, or the like with registered information of the at-home estimation rule.

The mobile device 10 or the management server 20 performs the process of updating the at-home probability data of the residence (residence A) using these pieces of data.

The update result is the data illustrated in FIG. 10(b).

This updated data is data acquired during the learning process period, which is data reflecting the following data:

at home probability=60% at 18:30 on Wednesday, January 11th, and

at-home probability=40% at 12:15 on Wednesday, January 18th.

Note that, the at-home probability data illustrated in FIG. 10 is one-day at-home probability data of the residence A on Wednesdays.

As described above, the at-home probability data can be generated as various units of data, such as one type of data in units of one day, seven types of data in units of day of week, or individual data for one year or 365 days. The example illustrated in FIG. 10 is at-home probability data in units of day of week.

FIG. 11 illustrates an example of the updating process by learning the at-home probability data of the same residence A on Mondays.

FIG. 11 illustrates following three pieces of at-home probability data of the same residence (residence A).

(a) At-home probability data before updating by learning process

(b) At-home probability data after updating by one-month learning process

(c) At-home probability data after updating by two-month learning process

FIG. 11(a) is at-home probability data before updating by learning process for the residence A, after this data is generated, the mobile device 10 repeats the traveling processing of passing in front of the residence A for a plurality of times in a predetermined period of time, and the mobile device 10 executes a learning process of calculating at-home probability data of each residence by comparing information acquired using a sensor such as a camera, a microphone, or the like with registered information of the at-home estimation rule.

The data updated as a result of the learning process of one month is the data illustrated in FIG. 11(b), and the data updated as a result of the learning process of two months is the data illustrated in FIG. 11(c).

During the one-month learning process, for example, the mobile device 10 acquires following observation information.

A bicycle is detected in front of residence A at 16:00 on Monday, May.
This information is information acquired by the mobile device 10 using a sensor such as a camera, a microphone, or the like.
The observation information is compared with the registered information of the at-home estimation rule to calculate new at-home probability data, and the at-home probability data updating process is executed on the basis of the calculated value.
This updated data is (b) at-home probability data after updating by one-month learning process.

Moreover, the mobile device 10 acquires, for example, the following observation information in a following month.

An umbrella is detected in front of residence A on a rainy day, at 18:00 on Monday, June.

This information is information acquired by the mobile device 10 using a sensor such as a camera, a microphone, or the like.

The observation information is compared with the registered information of the at-home estimation rule to calculate new at-home probability data, and the at-home probability data updating process is executed on the basis of the calculated value.

This updated data is (c) at-home probability data after updating by two-month learning process.

Note that the at-home probability data illustrated in FIG. 11 is one-day at-home probability data of the residence A on Mondays.

As described above, the mobile device 10 executes an at-home probability calculation process based on information acquired by a sensor such as a camera or the like while the mobile device 10 travels and the at-home estimation rules corresponding to a residence type inference, and generates and sequentially updates the at-home probability data for each residence using the calculation result.

Note that this process may be performed by the mobile device 10 itself, or may be performed by the management server 20.

In a case where the management server 20 performs the process, the information acquired by the mobile device 10, which is a sensor detection information such as a camera, a microphone, or the like is transmitted to the management server 20, and the management server 20 calculates at-home probability or generates or updates the at-home probability data on the basis of observation data received from the mobile device 10.

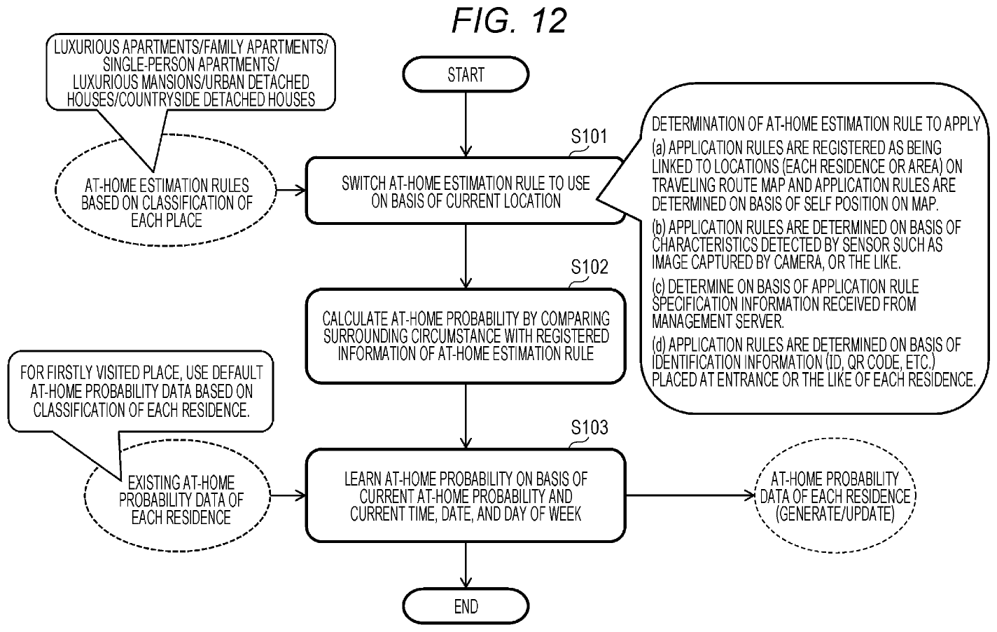

Next, the sequence of processing executed by the mobile device 10 will be described with reference to the flowchart illustrated in FIG. 12.

The processing according to the flowchart illustrated in FIG. 12 can be executed by the control unit (data processing unit) of the mobile device 10 according to a program stored in, for example, the storage unit of the mobile device 10. For example, the program execution processing can be performed by a processor such as a CPU having a program execution function.

Note that the flow illustrated in FIG. 12 can also be executed as processing of the management server 20 that can communicate with the mobile device 10.
In the following description, an example in which the mobile device 10 executes the process will be described.
The process of each step of the flow illustrated in FIG. 12 will be described below.

(Step S101)

First, the mobile device 10 determines an at-home estimation rule to apply on the basis of a current location.

The at-home estimation rule determination process is the process described above with reference to FIG. 9.

As described above, different at-home estimation rules are generated in advance depending on the type of residence, specifically, various residence types such as, for example, family apartments, luxurious apartments, studio apartments, single-person apartments, urban detached houses, suburban detached houses, mansions, and the like, and the at-home estimation rules corresponding to each residence type are stored in the storage unit of the mobile device 10 or the storage unit of the management server 20.

On the basis of the current location of the mobile device 10, the mobile device 10 selects one rule to use in a subsequent traveling process from the previously generated various at-home estimation rules corresponding to the resident types. This selection process is performed, for example, by any of following (a) to (d) as described above with reference to FIG. 9.

(a) The application rules are registered as being linked to locations (each residence or area) on the traveling route map and the application rules are determined on the basis of self position on the map.

(b) The application rules are determined on the basis of characteristics detected by a sensor such as an image captured by a camera, or the like.

(c) Determination is made on the basis of application rule specification information received from the management server.

(d) The application rules are determined on the basis of identification information (ID, QR code, etc.) placed at an entrance or the like of each residence.

(Step S102)

Next, in step S102, the mobile device 10 travels and acquires information (appearance characteristics) of the surrounding circumstances of each residence using a sensor such as a camera, a microphone, or the like, and compares the acquired information with registered information of the at-home estimation rule selected in step S101. On the basis of this comparison process, the at-home probability of each residence is calculated.

(Step S103)

Next, the mobile device 10 newly generates at-home probability data corresponding to each residence, or executes the process of updating the already-generated at-home probability data, on the basis of the at-home probability of the residence calculated in step S102.

Note that, in the case of a residence to be observed for the first time with no at-home probability data which has been made, default at-home probability data corresponding to the type of residence may be used and a process of updating the default at-home probability data may be executed.

### 3. (Second Embodiment) Process to Perform at-Home/Absence Estimation Based on Success or Failure of Delivery

Next, as a second embodiment of the present disclosure, a process example will be described in which information regarding whether or not a package has been actually delivered is acquired during execution of a package delivery process, and at-home/absence estimation is performed on the basis of the information.

As described above, the mobile device 10 executes the delivery process in the defined area almost every day. In this delivery process, there may be a case where the package has been delivered to each residence and a case where the package has not been delivered.

In the embodiment described below, in the actual delivery process performed by the mobile device 10, the case where the package has been delivered and the case where the package has not been delivered is acquired as observation information, and on the basis of the success or failure information of the package delivery, data for estimation (learning data) to estimate at-home or absence of each residence is generated.

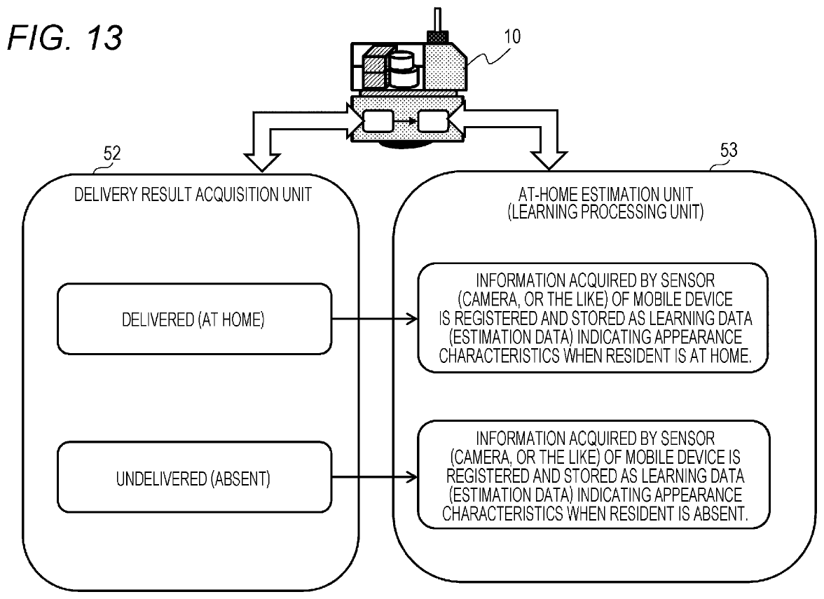

An outline of the process of the second embodiment will be described with reference to FIG. 13.

As illustrated in FIG. 13, the mobile device 10 includes a delivery result acquisition unit 52 and an at-home estimation unit (learning processing unit) 53.

Note that, there may be a configuration that the management server 20 performs the process of the at-home estimation unit (learning processing unit) 53.

In a package delivery process to a certain residence by the mobile device 10, the delivery result acquisition unit 52 acquires whether or not a package has been delivered, which is success/failure information of the delivery.

In a case where the delivery has been successful, the resident of the residence is at home, and the at-home information is input to the at-home estimation unit (learning processing unit) 53.

On the other hand, in a case where the package may not be delivered, the resident is absent, and absence information is input to the at-home estimation unit (learning processing unit) 53.

In a case where at-home information or absence information is input from the delivery result acquisition unit 52, the at-home estimation unit (learning processing unit) 53 analyzes observation information of a sensor such as a camera, a microphone, or the like of the mobile device at that time, and acquires appearance characteristic information.

For example, in a case where at-home information is input from the delivery result acquisition unit 52, the appearance characteristic information (observation information) acquired by the sensor such as a camera, a microphone, or the like of the mobile device is recorded and stored in the storage unit as learning data (estimation data).

On the other hand, when the absence information is input from the delivery result acquisition unit 52, appearance characteristic information (observation information) acquired by a sensor such as a camera, or a microphone, or the like of the mobile device is stored in the storage unit as learning data (estimation data).

After the learning data (estimation data) is recorded in the storage unit, the estimation of whether the resident is at-home or absent can be performed using the learning data (estimation data) stored in the storage unit.

Note that, the at-home estimation unit (learning processing unit) 53 generates learning data (estimation data) recorded as classifying the appearance characteristic information in a case where the resident is at home and the appearance characteristic information in a case where the resident is absent, which is at-home estimation data in other words.

Moreover, in a case where new at-home information or absence information from the delivery result acquisition unit 52 is input, or in a case where a new appearance characteristic is input, the at-home estimation unit (learning processing unit) 53 updates the learning data (estimation data).

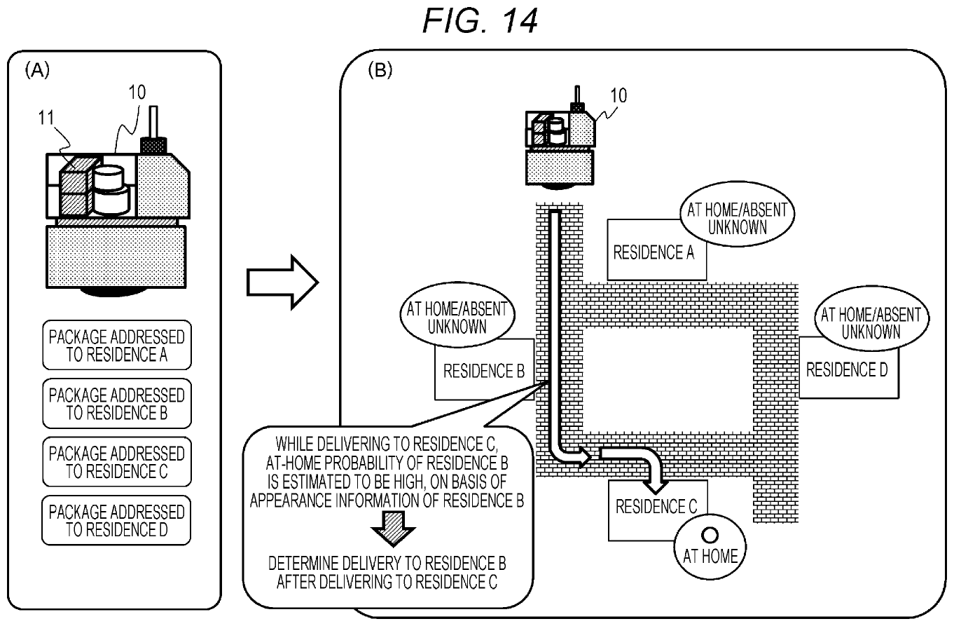

Next, with reference to FIG. 14, a specific delivery process example to which the processing of the second embodiment is applied will be described.

As illustrated in FIG. 14(A), in the mobile device 10, a plurality of packages 11 to be delivered is loaded on a loading platform in advance.

As illustrated in FIG. 14(A), the plurality of packages 11 loaded in the loading platform is packages addressed to residences in the area where the mobile device 10 travels. In other words, the following four packages are loaded:

a package addressed to residence A,

a package addressed to residence B,

a package addressed to residence C, and

a package addressed to residence D.

Here, the mobile device 10 performs a delivery process as illustrated in FIG. 14(B).

The mobile device 10 performs the delivery process to residence C, which has been previously confirmed as the resident is at home. It is assumed that it is unknown whether the residents of residences A, B, and D are at home or absent.

The mobile device 10 prioritizes and executes delivery to the residence C, which is confirmed as the resident is at home.

At this time, the mobile device 10 passes in front of the residence B and proceeds to the residence C, and the package delivery to the residence C is completed.

On this traveling route, the mobile device 10 passes in front of the residence B. When passing in front of the residence B, circumferences around the residence B are acquired by a sensor such as a camera, a microphone, or the like. The sensor acquisition information is input to the at-home estimation unit 53, and at-home/absence estimation of the residence B is performed using the learning data (estimation data).

For example, there is a bicycle in front of the residence B. Alternatively, it is assumed that observation information (appearance characteristic formation) such that room light is on is acquired. The observation information (appearance characteristic information) is registered in the storage unit as data for estimation (learning data) indicating that the resident is at home. The at-home estimation unit 53 of the mobile device 10 performs a process of comparing the observation information with the data for estimation (learning data) registered in the storage unit and, as a result of this comparison, it is estimated that the possibility that resident of the residence B is at home to be high.

After the delivery of the package to the residence C is completed, the mobile device 10 returns to the residence B and delivers the package to the residence B according to the estimation.

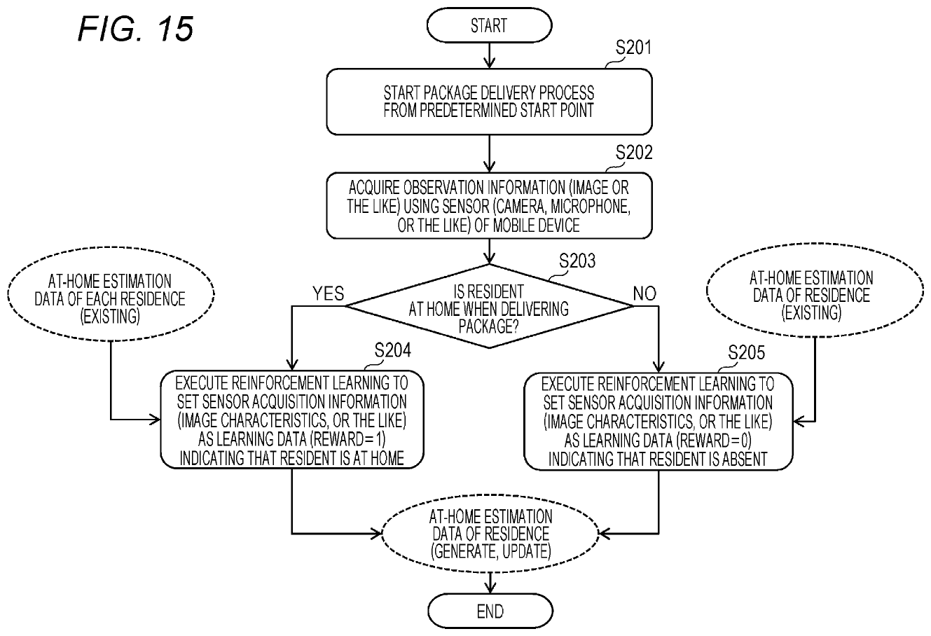

Next, a sequence of processing performed by the mobile device 10 according to the second embodiment will be described with reference to the flowchart illustrated in FIG. 15.

The processing according to the flowchart illustrated in FIG. 15 can be performed by the control unit (data processing unit) of the mobile device 10 according to a program stored in, for example, the storage unit of the mobile device 10. For example, the program execution processing can be performed by a processor such as a CPU having a program execution function.

Note that the flow illustrated in FIG. 15 can also be executed as processing of the management server 20 that can communicate with the mobile device 10.

In the following description, an example in which the mobile device 10 executes the process will be described.

The process of each step of the flow illustrated in FIG. 15 will be described below.

(Step S201)

First, the mobile device 10 starts the package delivery process from a predetermined start point.

(Step S202)

Next, in step S202, the mobile device 10 acquires observation information (such as an image, or the like) using a sensor (such as a camera, a microphone, or the like) of the mobile device.

(Step S203)

Next, in step S203, the mobile device 10 acquires information regarding whether the resident of the residence of the package delivery destination is at home or absent.

In a case where the resident is at home, the process proceeds to step S204.

In a case where the resident is absent, the process proceeds to step S205.

(Step S204)

The process of step S204 is a process performed in a case where it is estimated that the resident of the residence of the package delivery destination is at home in step S203.

In this case, in step S204, the mobile device 10 performs reinforcement learning in which sensor acquisition information (such as characteristics of an image) is used as learning data (reward=1) indicating that the resident is at home.

This process is a process performed by the at-home estimation unit (learning processing unit) 53 described above with reference to FIG. 13.

The process of step S204 is a process in a case where the at-home estimation unit (learning processing unit) 53 inputs at-home information from the home-delivery result acquisition unit 52.

In a case where at-home information is input from the home-delivery result acquisition unit 52, the at-home estimation unit (learning processing unit) 53 records and stores appearance characteristic information (observation information) acquired by a sensor such as a camera, a microphone, or the like of the mobile device 10 in the storage unit as learning data (estimation data) indicting characteristics of a case where the resident is at home. This process corresponds to the process of step S204.

(Step S205)

On the other hand, the process of step S205 is a process executed in a case where it is estimated that the resident of the residence the package delivery destination is absent in step S203.

In this case, in step S205, the mobile device 10 executes reinforcement learning in which sensor acquisition information (such as characteristics of an image) is used as learning data (reward=0) indicating that the resident is absent.

This process is a process performed by the at-home estimation unit (learning processing unit) 53 described above with reference to FIG. 13.

The process of step S205 is a process in a case where the at-home estimation unit (learning processing unit) 53 receives an input from the absence information from the delivery result acquisition unit 52.

In a case where absence information is input from the delivery result acquisition unit 52, the at-home estimation unit (learning processing unit) 53 records and stores appearance characteristic information (observation information) acquired by a sensor such as a camera, a microphone, or the like of the mobile device 10 in the storage unit as learning data (estimation data) indicating characteristics of a case where the resident is absent. This process corresponds to the process of step S205.

By the learning process in step S204 or step S205, new at-home estimation data (learning data) corresponding to the residence is generated or updated and stored in the storage unit.

The new data stored in the storage unit will be referred to for the at-home/absence estimation after this processing.

### 4. (Third Embodiment) Process to Perform at-Home/Absence Estimation Based on Success or Failure of Delivery while Performing Calculation and Update Processes of at-Home Probability Data Based on a Comparison Between Observation Information of Residence and at-Home Estimation Rules (First and Second Embodiments)

Next, an embodiment in which the first embodiment and the second embodiment described above are executed together will be described as a third embodiment. In other words, an embodiment will be described in which calculation and update processes of at-home probability data based on comparison of observation information of a residence and at-home estimation rules are performed, and at-home/absence estimation based on success or failure of delivery is performed.

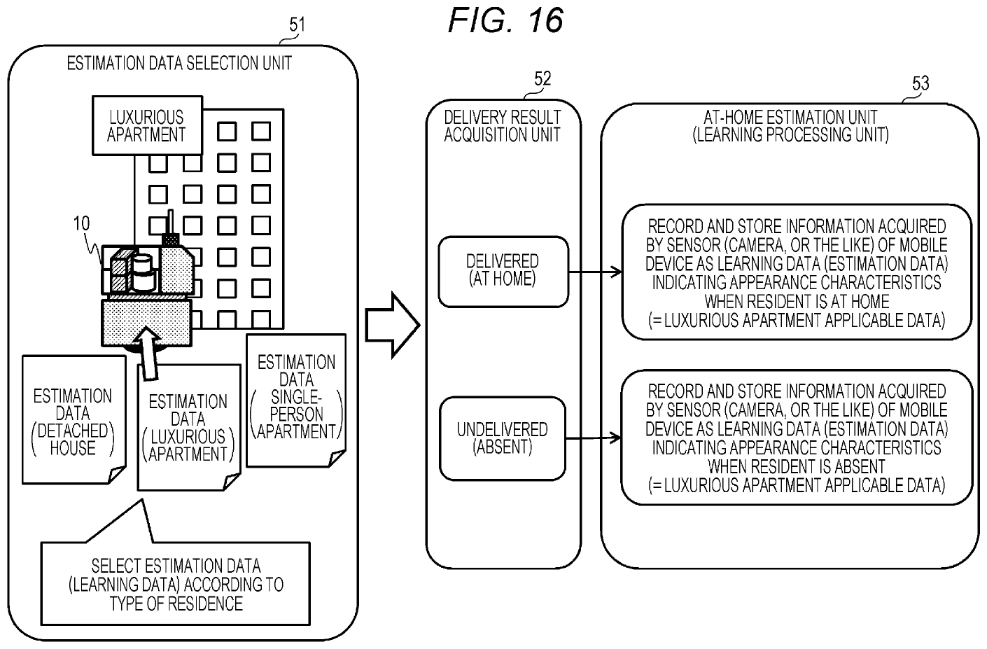

A processing example of the third embodiment will be described with reference to FIG. 16.

FIG. 16 illustrates the processing of the following three processing units of the mobile device 10.

The estimation data selection unit 51,

the delivery result acquisition unit 52, and

the at-home estimation unit (learning processing unit) 53,

are the three processing units.

The estimation data selection unit 51 selects “data for estimation (at-home/absence estimation data)” to be used in a case where the at-home/absence estimation is performed.

The data for estimation for performing at-home/absence estimation is stored in the storage unit of the mobile device 10 or the storage unit of the management server 20. This “data for estimation (at-home/absence estimation data)” differs depending on the type of delivery destination residence, for example, apartments, detached houses, or the like, as in the case of “at-home estimation rules” in the first embodiment described above.
For example, different “data for estimate (at-home/absence estimation data)” is stored in the storage unit depending on various residence types such as family apartments, luxurious apartments, studio apartments, single-person apartments, urban detached houses, suburban detached houses, mansions, and the like.

The mobile device 10 selects “data for estimation (at-home/absence estimation data)” to be used from the storage unit in accordance with the type of residence as a delivery destination.

In the example illustrated in FIG. 16, since the delivery destination residence type is a luxurious apartment, the estimation data selection unit 51 of the mobile device 10 selects “data for estimate (at-home/absence estimation data)” for luxurious apartments from the storage unit.

The packages are delivered by giving priority to a residence estimated as the resident being at home while performing at-home/absence estimation of each delivery destination using the selected estimation data.

In the case of actual delivery of the packages, the delivery result acquisition unit 52 executes the process.

In the package delivery process to each residence, the delivery result acquisition unit 52 acquires whether or not the package has been delivered to the residence, or the success/failure information of the delivery, in other words.

In a case where the delivery is successful, since the resident is at home, the at-home information is input to the at-home estimation unit (learning processing unit) 53.

On the other hand, in a case where the delivery has not been performed, since the resident is absent, the absence information is input to the at-home estimation unit (learning processing unit) 53.

In a case where at-home information or absence information is input from the delivery result acquisition unit 52, the at-home estimation unit (learning processing unit) 53 analyzes observation information of a sensor such as a camera, a microphone, or the like of the mobile device at that time, and acquires appearance characteristic information.

For example, in a case where at-home information is input from the delivery result acquisition unit 52, the appearance characteristic information (observation information) acquired by the sensor such as a camera, a microphone, or the like of the mobile device is recorded and stored in the storage unit as learning data (estimation data).

On the other hand, when the absence information is input from the delivery result acquisition unit 52, appearance characteristic information (observation information) acquired by a sensor such as a camera, or a microphone, or the like of the mobile device is stored in the storage unit as learning data (estimation data).

After recording the learning data (estimation data) in the storage unit, estimation of whether the resident of the residence is at home or absence can be performed by using the learning data (estimation data) stored in the storage unit.

In this embodiment, in addition to the at-home/absence estimation using the “data for estimation (learning data)”, the process of estimating the at-home probability using the at-home probability data and a process of generating and updating the at-home probability described above in the first embodiment are also performed.

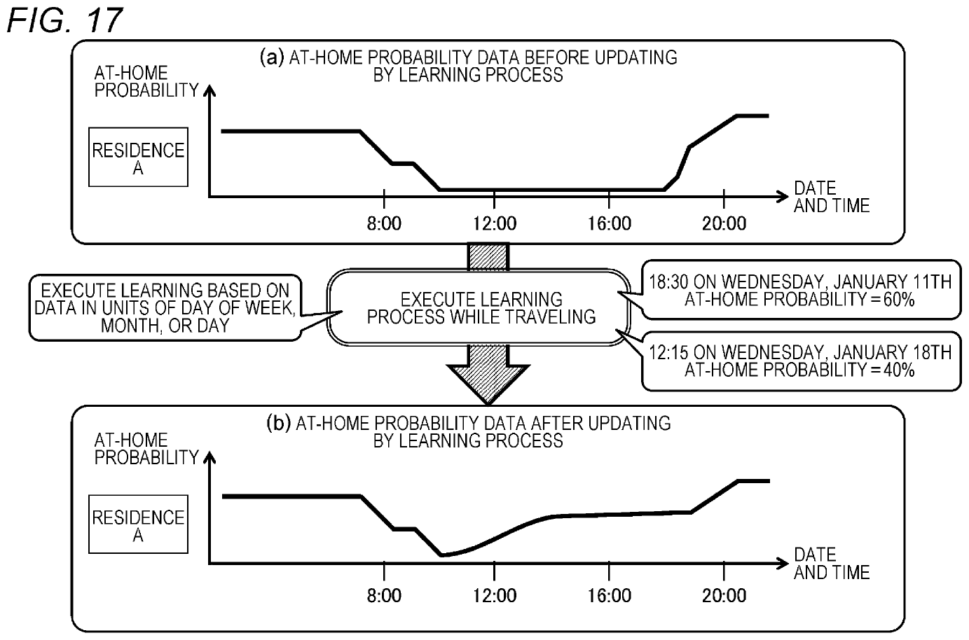

FIG. 17 is a diagram illustrating an example of the process of generating and updating the at-home probability data.

FIG. 17 illustrates following two pieces of at-home probability data regarding the same residence (residence A).

(a) At-home probability data before updating by learning process

(b) At-home probability data after updating by learning processing

FIG. 17(a) illustrates the at-home probability data before updating by the learning process related to the residence A, and after this data is generated, the mobile device 10 repeats the traveling process of passing in front of the residence A for a plurality of times in a predetermined period of time, and the mobile device 10 executes a learning process of calculating at-home probability data of each residence by comparing information acquired using a sensor such as a camera, a microphone, or the like with registered information of the at-home estimation rule. The data updated as a result of the learning process for the predetermined period is the data illustrated in FIG. 17(b).

In the period of the learning process within the predetermined period, the mobile device 10 acquires, for example, following at-home probability calculation data.

At-home probability=60% at 18:30 on Wednesday, January 11th

At-home probability=40% at 12:15 on Wednesday, January 18th

These pieces of at-home probability calculation data are data calculated by the mobile device 10 comparing information acquired by using a sensor such as a camera, a microphone, or the like with registered information of the at-home estimation rule.

The mobile device 10 or the management server 20 performs the process of updating the at-home probability data of the residence (residence A) using these pieces of data.

The update result is data illustrated in FIG. 17(b).

This updated data is data acquired during the learning process period, which is data reflecting the following data:

at home probability=60% at 18:30 on Wednesday, January 11th, and
at-home probability=40% at 12:15 on Wednesday, January 18th.
Note that the at-home probability data illustrated in FIG. 17 is one-day at-home probability data of residence A on Wednesdays.

As described above, the at-home probability data can be generated as various units of data, such as one type of data in units of one day, seven types of data in units of day of week, or individual data for one year or 365 days. The example illustrated in FIG. 17 is at-home probability data in units of days of week.

In the third embodiment, as described above, the mobile device 10 acquires observation information (appearance characteristics) of each residence as in the first embodiment, and also generates and updates the at-home probability data of each residence on the basis of the acquired observation information (appearance characteristics).

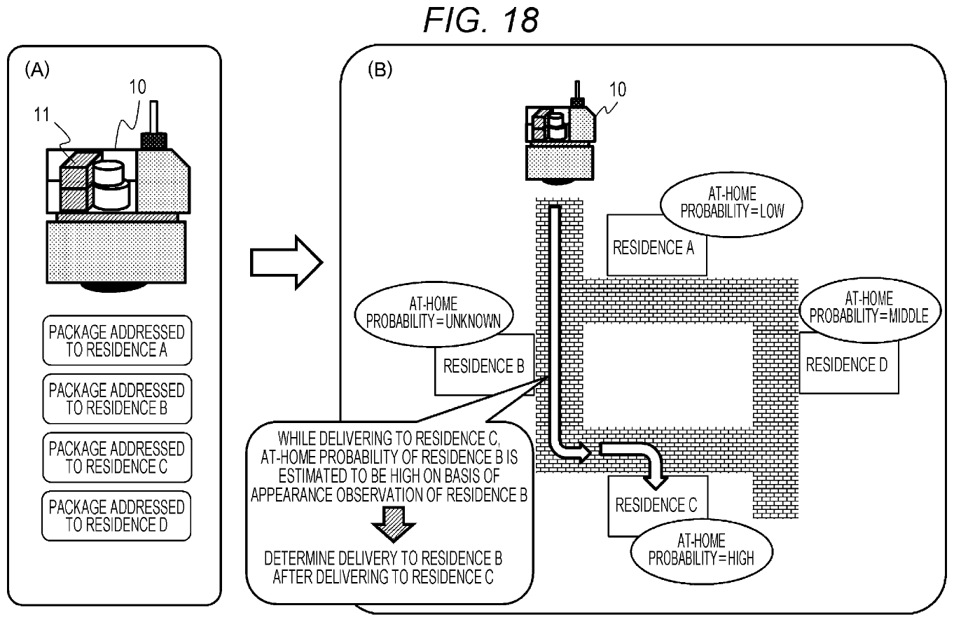

Next, a specific delivery process example to which the processing of the third embodiment is applied will be described with reference to FIG. 18.

As illustrated in FIG. 18(A), in the mobile device 10, a plurality of packages 11 to be delivered is loaded on a loading platform in advance.

As illustrated in FIG. 18(A), the plurality of packages 11 loaded in the loading platform is packages addressed to residences in an area where the mobile device 10 travels. In other words, the following four packages are loaded:

a package addressed to residence A,

a package addressed to residence B,

a package addressed to residence C, and

a package addressed to residence D.

Here, the mobile device 10 performs a delivery process as illustrated in FIG. 18(B).

First, the mobile device 10 acquires, from the memory in the mobile device 10 or the management server 20 capable of communicating with the mobile device 10, at-home probability data of each residence in the moving area of the package delivery destination. This is the at-home probability data generated in the first embodiment.

As a result, as illustrated in FIG. 18(B), it is assumed that the at-home probability of each residence is acquired as follows.

At-home probability of residence A=low

At-home probability of residence B=unknown

At-home probability of residence C=high

At-home probability of residence D=middle

For example, since residence B is newly built or the like and at-home probability data has not been generated, it is defined as unknown.

The mobile device 10 gives priority to the delivery to the residence C having a high at-home probability, on the basis of the at-home probability of each of the abovementioned residences A to D.

At this time, the mobile device 10 passes in front of the residence B and proceeds to the residence C, and the package delivery to the residence C is completed.

On this traveling route, the mobile device 10 passes in front of the residence B. When passing in front of the residence B, the circumstances around the residence B is acquired by a sensor such as a camera, a microphone, or the like. The sensor acquisition information is input to the at-home estimation unit 53, and at-home/absence estimation of the residence B is performed using the learning data (estimation data).

For example, there is a bicycle in front of the residence B. Alternatively, it is assumed that observation information (appearance characteristic formation) such that room light is on is acquired. The observation information (appearance characteristic information) is registered in the storage unit as data for estimation (learning data) indicating that the resident is at home. The at-home estimation unit 53 of the mobile device 10 performs a process of comparing the observation information with the estimation data (learning data) registered in the storage unit, and as a result of this comparison, it is estimated that the possibility that the resident of the residence B to be high.

After the delivery of the package to the residence C is completed, the mobile device 10 returns to the residence B and delivers the package to the residence B according to the estimation.

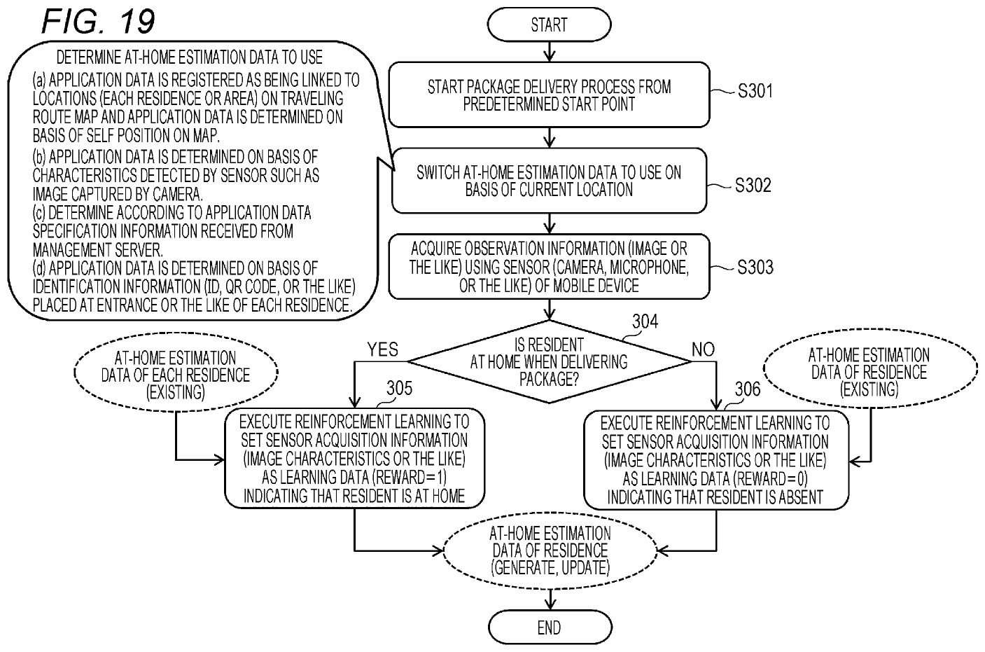

Next, a sequence of processing executed by the mobile device 10 according to the third embodiment will be described with reference to flowcharts illustrated in FIG. 19 and following drawings.

The following three processes executed by the mobile device 10 according to the third embodiment will be sequentially described with reference to individual flowcharts.

(Process 1) Learning process sequence in the at-home estimation unit (FIG. 19)

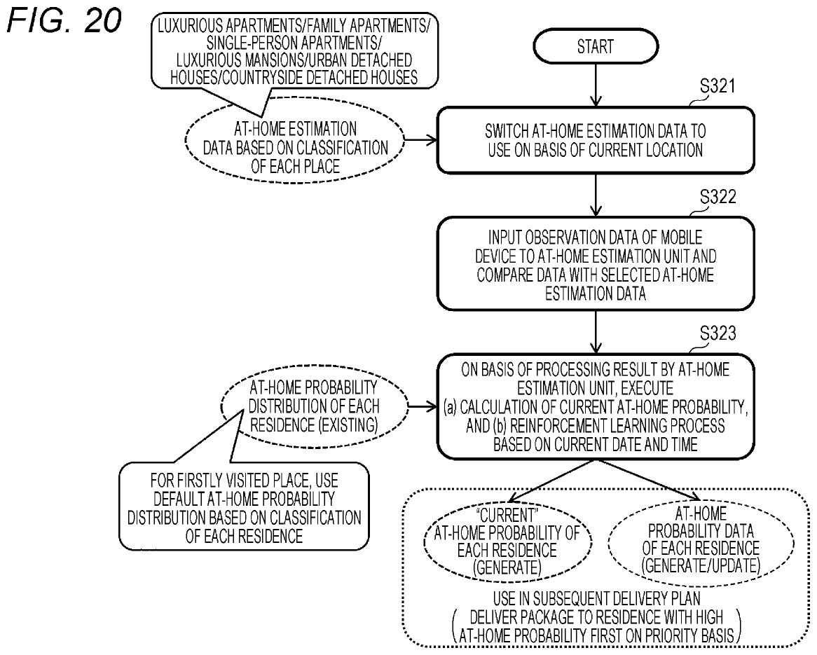

(Process 2) At-home probability calculation process sequence (FIG. 20)

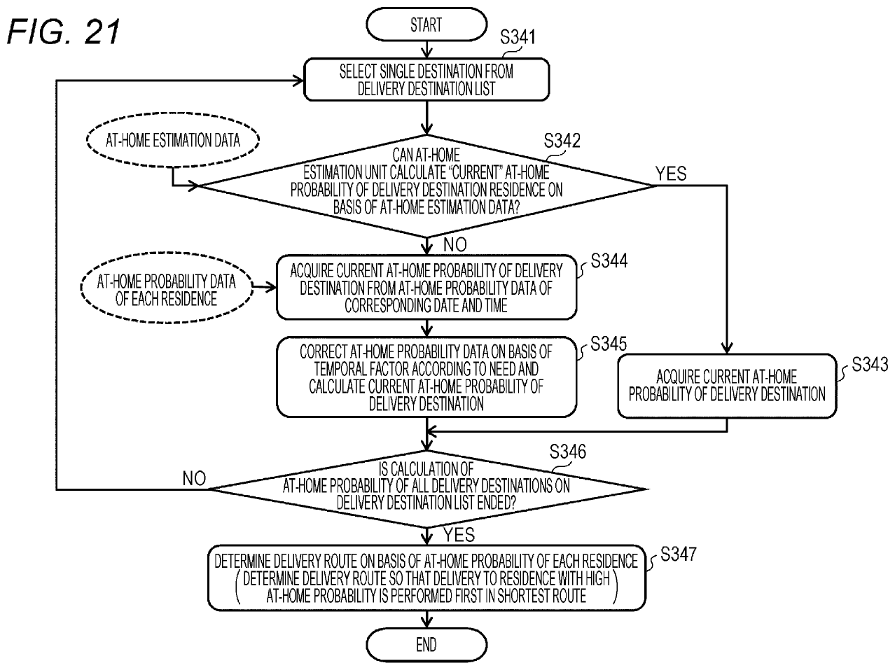

(Process 3) Delivery route determination process sequence based on at-home probability (FIG. 21)

Note that the processes according to the flowcharts illustrated in FIGS. 19 to 21 can be executed by the control unit (data processing unit) of the mobile device 10 according to a program stored in the storage unit of the mobile device 10, for example. For example, the program execution processing can be performed by a processor such as a CPU having a program execution function.

Note that the flows illustrated in FIGS. 19 to 21 can also be executed as processing of the management server 20 capable of communicating with the mobile device 10.

In the following description, an example in which the mobile device 10 executes the process will be described.

(Process 1) Learning processing sequence in at-home estimation unit

First, the learning processing sequence executed by the at-home estimation unit (learning processing unit) 53 of the mobile device 10 will be described according to the flowchart illustrated in FIG. 19.

The process of each step of the flow illustrated in FIG. 19 will be described below.

(Step S301)

First, the mobile device 10 starts the package delivery process from a predetermined start point.

(Step S302)

Next, in step S302, the mobile device 10 executes a process for switching the data for at-home estimation (learning data) used by the at-home estimation unit (learning processing unit) 53 on the basis of the current location of the mobile device 10.

Different data is generated in advance as at-home estimation data used by the at-home estimation unit (learning processing unit) 53 depending on a type of residence, specifically, for example, family apartments, a luxurious apartments, studio apartments, single-person apartments, urban detached houses, suburban detached houses, mansions, and the like, and at-home estimation data corresponding to each residence type is stored in the storage unit of the mobile device 10 or the storage unit of the management server 20.

On the basis of the current location of the mobile device 10, the mobile device 10 selects one piece of data to be used for a traveling process from various pieces of at-home estimation data (learning data) corresponding to a previously generated residence type. This selection process is performed, for example, by any of the following (a) to (d).

(a) The application rules are registered as being linked to positions (each residence or area) on the traveling route map and the at-home estimation data to be applied is determined from the self position on the map.

(b) The at-home estimation data to be applied is determined on the basis of characteristics detected by a sensor such as an image captured by a camera, or the like.

(c) Determination is made on the basis of at-home estimation data specification information received from the management server.

(d) The at-home estimation data to be applied is determined on the basis of identification information (ID, QR code, etc.) placed at an entrance or the like of each residence.

(Step S303)

Next, in step S303, the mobile device 10 acquires observation information (such as an image) using a sensor (such as a camera, a microphone, or the like) of the mobile device.

(Step S304)

Next, in step S304, the mobile device 10 acquires information regarding whether the resident of the residence of the package delivery destination is at home or absent.

In a case where the resident is at home, the process proceeds to step S305.

In a case where the resident is absent, the process proceeds to step S306.

(Step S305)

The process of step S305 is a process executed in a case where it is estimated that the resident of the package delivery destination is at home in step S304.

In this case, in step S305, the mobile device 10 performs reinforcement learning in which sensor acquisition information (such as characteristics of an image or the like) is used as learning data (reward=1) indicating that the resident is at home.

This process is a process performed by the at-home estimation unit (learning processing unit) 53 described above with reference to FIG. 16.

The process of step S305 is a process in a case where the at-home estimation unit (learning processing unit) 53 receives at-home information from the delivery result acquisition unit 52.

In a case where at-home information is input from the home-delivery result acquisition unit 52, the at-home estimation unit (learning processing unit) 53 records and stores appearance characteristic information (observation information) acquired by a sensor such as a camera, a microphone, or the like of the mobile device 10 in the storage unit as learning data (estimation data) indicting characteristics of a case where the resident is at home. This process corresponds to the process of step S305.

(Step S306)

On the other hand, the process of step S306 is a process performed in a case where it is estimated that the resident of the package delivery destination is absent in step S304.

In this case, in step S306, the mobile device 10 performs reinforcement learning in which sensor acquisition information (such as characteristics of an image) is used as learning data (reward=0) indicating that the resident is absent.

This process is a process performed by the at-home estimation unit (learning processing unit) 53 described above with reference to FIG. 16.

The process of step S306 is a process in a case where the at-home estimation unit (learning processing unit) 53 receives the absence information from the delivery result acquisition unit 52.

In a case where absence information is input from the delivery result acquisition unit 52, the at-home estimation unit (learning processing unit) 53 records and stores appearance characteristic information (observation information) acquired by a sensor such as a camera, a microphone, or the like of the mobile device 10 in the storage unit as learning data (estimation data) indicating characteristics of a case where the resident is absent. This process corresponds to the process of step S306.

By the learning process of step S305 or step S306, new at-home estimation data (learning data) corresponding to the residence is generated or updated and stored in the storage unit.

The new data stored in the storage unit will be referred to for the at-home/absence estimation after this processing.

(Process 2) At-home probability calculation process sequence

Next, with reference to a flowchart illustrated in FIG. 20, a process sequence of calculating the at-home probability performed by the data processing unit of the mobile device 10 will be described.

The process of each step of the flow illustrated in FIG. 20 will be described below.

(Step S321)

First, in step S321, the mobile device 10 performs a process for switching the at-home estimation data (learning data) used by the at-home estimation unit (learning processing unit) 53 on the basis of the current location of the mobile device 10.

Different data is generated in advance as at-home estimation data used by the at-home estimation unit (learning processing unit) 53 depending on a type of residence, specifically, for example, family apartments, a luxurious apartments, studio apartments, single-person apartments, urban detached houses, suburban detached houses, mansions, and the like, and at-home estimation data corresponding to each residence type is stored in the storage unit of the mobile device 10 or the storage unit of the management server 20.

On the basis of the current location of the mobile device 10, the mobile device 10 selects one piece of data to be used for a traveling process from various pieces of at-home estimation data (learning data) corresponding to a previously generated residence type. This selection process is performed, for example, by any of the following (a) to (d).

(a) The application rules are registered as being linked to positions (each residence or area) on the traveling route map and the at-home estimation data to be applied is determined from the self position on the map.

(b) The at-home estimation data to be applied is determined on the basis of characteristics detected by a sensor such as an image captured by a camera, or the like.

(c) Determination is made on the basis of at-home estimation data specification information received from the management server.

(d) The at-home estimation data to be applied is determined on the basis of identification information (ID, QR code, etc.) placed at an entrance or the like of each residence.

(Step S322)

Next, in step S322, the mobile device 10 acquires observation information (such as an image or the like) using a sensor (such as a camera, a microphone, or the like) of the mobile device and inputs acquired observation information to the at-home estimation unit (learning processing unit) 53 and the at-home estimation unit (learning processing unit) 53 executes a process of comparing the input observation information with the at-home estimation data selected in step S321.

(Step S323)

Next, in step S323, the mobile device 10 inputs the comparison result of the observation information and the at-home estimation data in step S322, and “the previously generated at-home probability data corresponding to each residence”, and performs following processes:

(a) calculation of the current at-home probability, and

(b) reinforcement learning process based on the current date and time.

Note that “previously generated at-home probability data corresponding to each residence” is, for example, the data illustrated in FIG. 17 and is at-home probability data generated in the above described first embodiment.

The process (b) is a process corresponding to the learning process described with reference to FIG. 17.

As a process result of step S323,

the current at-home probability of each residence is calculated in the process (a), and the at-home probability data corresponding to the date and time is generated or updated in the process (b).

These pieces of data are used for processing such as determination of a delivery route, which will be described as (Process 3).

Note that the date and time represent both date and time, or at least one of date or time.

(Process 3) Delivery route determination process sequence based on at-home probability

Next, with reference to a flowchart illustrated in FIG. 21, a process sequence of determining a delivery route based on the at-home probability performed by the data processing unit of the mobile device 10 will be described.

The process of each step of the flow illustrated in FIG. 21 will be described below.

(Step S341)

First, the mobile device 10 sequentially selects one residence as a delivery destination from the delivery destination list. Note that the delivery destination list is input to the mobile device 10 in advance. Alternatively, the delivery destination list is acquired from the management server 20.

(Step S342)

Next, in step S342, the mobile device 10 estimates whether or not the at-home estimation unit (learning processing unit) 53 can calculate the “current” at-home probability of the delivery destination residence on the basis of the home estimation data.

For example, in a case where the mobile device 10 has passed in front of the delivery destination residence just before this processing and acquired observation information of the delivery destination residence, the “current” at-home probability can be calculated by comparing the observation information and the at-home estimation data (learning data) so that the estimation in step S342 becomes Yes.

Otherwise, the estimate in step S342 becomes No.

In a case where it is estimated that the “current” at-home probability of the delivery destination residence can be calculated, the process proceeds to step S343.

On the other hand, in a case where it is estimated that the “current” at-home probability of the delivery destination residence may not be calculated, the process proceeds to step S344.

(Step S343)

In step S342, in a case where it is estimated that the “current” at-home probability of the delivery destination residence can be calculated, the process proceeds to step S343.

In step S343, the mobile device 10 calculates the “current” at-home probability by comparing latest observation information of the delivery destination residence with the at-home estimation data (learning data).

This process is a process performed by the at-home estimation unit (learning processing unit) 53 of the mobile device 10.

(Step S344)

On the other hand, in step S342, in a case where it is estimated that the “current” at-home probability of the delivery destination residence may not be calculated, the process proceeds to step S344.

In step S344, the mobile device 10 acquires, from the storage unit, the previously generated at-home probability data of the delivery destination residence, which is the at-home probability data corresponding to the date and time as described with reference to FIG. 17, for example.

(Step S345)

Next, the mobile device 10 performs a correction process based on temporal factors on the at-home probability data of the delivery destination residence acquired in step S344 according to need.

This process is, for example, the processes described above with reference to FIGS. 7 and 8.

In a case where the current date and time is in a special day when the at-home probability decreases (the year-end and New Year holidays, or the like) as described with reference to FIG. 7, the correction process is performed to decrease the at-home probability from the one-day at-home probability data for a normal day.

Furthermore, in a case where the current date and time is on a special day when the at-home probability increases (a day when a high television rating event (the Olympics, etc.) is held, or the like), as described with reference to FIG. 8, a correction process is performed to increase at-home probability data for a normal day.

Moreover, in step S345, the at-home probability corresponding to the current date and time is calculated using the corrected at-home probability data.

(Step S346)

Next, in step S346, it is estimated whether or not the processes have been completed for all delivery destinations in the delivery destination list.

In a case where there is an unprocessed delivery destination, the processes of steps S341 to S345 are executed for the unprocessed delivery destination.

In S346, in a case where it is estimated that the processes have been completed for all delivery destinations in the delivery destination list, the process proceeds to step S347.

(Step S347)

Finally, in step S347, the mobile device 10 determines a delivery route on the basis of the at-home probabilities of all the delivery destinations recorded in the delivery destination list.

In the process of determining the delivery route is, for example, determination is made so that priority is given to a residence having a high at-home probability and the delivery route becomes a shortest route.

As described above, in the configuration of the third embodiment, by selectively using the at-home probability acquired by comparing the current or latest observation information of the delivery destination residence with the at-home estimation data (the at-home probability acquired by the process of the second embodiment) and the previously generated at-home probability data corresponding to date and time (the at-home probability acquired by the process of the first embodiment), efficient and highly accurate at-home probability can be calculated and an optimal delivery route based on the calculated at-home probability can be determined.

### 5. Configuration Example of Mobile Device

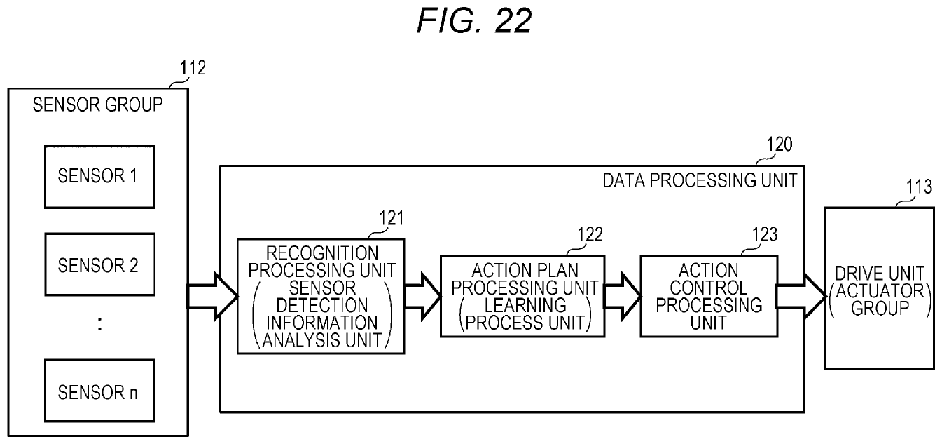

Next, a configuration example of the mobile device 10 will be described with reference to FIG. 22.

FIG. 22 is a block diagram illustrating a partial configuration of the mobile device 10, and is a block diagram illustrating main components used to execute processes according to the above-described embodiments.

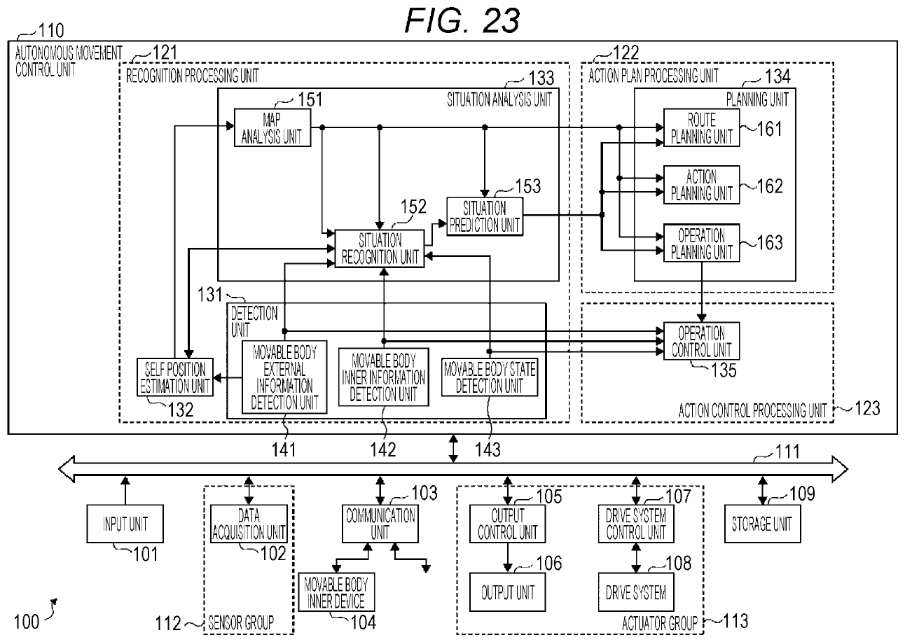

FIG. 23 is a diagram illustrating an example of an overall configuration of the mobile device 10.

First, with reference to FIG. 22, the main components that execute the processes according to each of the embodiments described above will be described.

As illustrated in FIG. 22, the mobile device 10 includes a sensor group 112, a data processing unit 120, and a drive unit (actuator group) 113.

The data processing unit 120 includes a recognition processing unit (sensor detection information analysis unit) 121, an action plan processing unit (learning processing unit) 122, and an action control processing unit 123.

The sensor group 112 includes various sensors such as a camera, a microphone, a distance sensor, and the like. More specifically, for example, the sensor group 112 includes an all-around camera or a fish-eye camera capable of capturing the entire surroundings, a light detection and ranging or a laser Imaging detection and ranging (LiDAR) that acquires surrounding information using pulsed laser light, or the like.

The sensor group 112 further includes a sensor that detects whether or not the loaded package is taken out. In other words, a sensor for acquiring detection information for estimating success or failure of delivery in the delivery result acquisition unit 52 described with reference to FIGS. 13 and 16 is also included.

The data processing unit 120 includes a recognition processing unit (sensor detection information analysis unit) 121, an action plan processing unit (learning processing unit) 122, and an action control processing unit 123.

The recognition processing unit (sensor detection information analysis unit) 121 inputs detection information of each sensor constituting the sensor group 112 and analyzes the detection information.

More specifically, analysis of an image captured by the camera, analysis of voice acquired by the microphone, analysis of detection information of the distance sensor, and analysis of presence or absence of the package are performed.

The analysis of the appearance characteristic of each residence is executed in the recognition processing unit (sensor detection information analysis unit) 121.

The information analyzed by the recognition processing unit (sensor detection information analysis unit) 121 is input to the action plan processing unit (learning processing unit) 122.

The action plan processing unit (learning processing unit) 122 performs processing such as generation and update of at-home probability data described in the above-described embodiment, calculation processing of at-home probability of each residence, and determination of a delivery route based on the calculated at-home probability.

Note that data necessary for these processes, such as at-home probability data, at-home estimation rules, at-home estimation data, and the like, for example, are stored in an unillustrated storage unit. The action plan processing unit (learning processing unit) 122 performs the processes of generating and updating at-home probability data, using the data acquired from the storage unit and the data acquired by the sensor group 112 and analyzed by the recognition processing unit 121, calculating at-home probability of each residence, and determining a delivery route based on the calculated at-home probability.

The delivery route information determined by the action plan processing unit (learning processing unit) 122 is input to the action control processing unit 123.

The action control processing unit 123 causes the drive unit 113 to move the mobile device 10 according to the delivery route determined by the action plan processing unit (learning processing unit) 122, and executes the delivery process.

Next, an example of the overall configuration of the mobile device 10 will be described with reference to FIG. 23.

FIG. 23 illustrates an example of the overall configuration of a mobile device 100, which corresponds to the mobile device 10.

The mobile device 100 includes an input unit 101, a data acquisition unit 102, a communication unit 103, a movable body inner device 104, an output control unit 105, an output unit 106, a drive system control unit 107, a drive system 108, a storage unit 109, and an autonomous movement control unit 110. Note that the movable body represents the mobile device 100 itself.

The data acquisition unit 102 includes the sensor group 112 described with reference to FIG. 22.

The autonomous movement control unit 110 corresponds to the data processing unit 120 described with reference to FIG. 22 and includes a recognition processing unit 121, an action plan processing unit 122, and an action control processing unit 123.

Furthermore, the output control unit 105, the output unit 106, the drive system control unit 107, and the drive system 108 correspond to the components of the drive unit 113 described with reference to FIG. 22.

The input unit 101, the data acquisition unit 102, the communication unit 103, the output control unit 105, the drive system control unit 107, the storage unit 109, and the autonomous movement control unit 110 are connected to one another via the communication network 111. The communication network 111 includes, for example, an onvehicle communication network or bus conforming to any standard such as a controller area network (CAN), a local interconnect network (LIN), a local area network (LAN), or FlexRay (registered trademark). Note that each unit of the mobile device 100 may be directly connected without the communication network 111.

Note that, in the following, in a case where each unit of the mobile device 100 performs communication via the communication network 111, the description of the communication network 111 will be omitted. For example, in a case where the input unit 101 and the autonomous movement control unit 110 perform communication via the communication network 111, it is simply described that the input unit 101 and the autonomous movement control unit 110 perform communication.

The input unit 101 includes a device used to input various data and instructions. For example, the input unit 101 includes an operation device such as a touch panel, a button, a microphone, a switch, and a lever, and an operation device that can input data by a method other than manual operation but by voice, gesture, or the like. Furthermore, for example, the input unit 101 may be a remote control device using infrared rays or other radio waves, or an externally connected device such as a mobile device or a wearable device compatible with the operation of the mobile device 100. The input unit 101 generates an input signal on the basis of on input data, an instruction, and the like, and supplies the input signal to each unit of the mobile device 100.

The data acquisition unit 102 includes various sensors or the like that acquire data used for processing of the mobile device 100, and supplies the acquired data to each unit of the mobile device 100.

For example, the data acquisition unit 102 includes various sensors for detecting the state of the vehicle. More specifically, for example, the data acquisition unit 102 includes a gyro sensor, an acceleration sensor, an inertial measurement device (IMU), a sensor for detecting a motor rotational speed or a wheel rotational speed, or the like.

Furthermore, for example, the data acquisition unit 102 includes various sensors for detecting information outside the vehicle. More specifically, for example, the data acquisition unit 102 includes an imaging device such as a time of flight (ToF) camera, a stereo camera, a monocular camera, an infrared camera, other cameras, and the like. Furthermore, for example, the data acquisition unit 102 includes a microphone, an environment sensor for detecting weather, atmospheric phenomena, and the like, and an surrounding information detection sensor for detecting an object around the vehicle. The environment sensor includes, for example, a raindrop sensor, a fog sensor, a sunshine sensor, a snow sensor, and the like. The surrounding information detection sensor includes, for example, an ultrasonic sensor, a radar, light detection and ranging or laser imaging detection and ranging (LiDAR), a sonar, or the like.

Moreover, for example, the data acquisition unit 102 includes various sensors for detecting the current location of the vehicle. More specifically, for example, the data acquisition unit 102 includes a global navigation satellite system (GNSS) receiver or the like which receives a GNSS signal from a GNSS satellite.

The communication unit 103 communicates with the movable body inner device 104 and various devices outside the vehicle, a server, a base station, and the like, and transmits data supplied from each unit of the mobile device 100, or supplies received data to each part of the mobile device 100. Note that a communication protocol supported by the communication unit 103 is not particularly limited, and the communication unit 103 can also support a plurality of types of communication protocols.

For example, the communication unit 103 performs wireless communication with the movable body inner device 104 by wireless LAN, Bluetooth (registered trademark), near field communication (NFC), wireless USB (WUSB), or the like. Furthermore, for example, the communication unit 103 may use a universal serial bus (USB), a high-definition multimedia interface (HDMI (registered trademark)), or an mobile high-definition link (MHL) via an unillustrated connection terminal (and a cable, if necessary) to perform wired communication with the movable body inner device 104.

Moreover, for example, the communication unit 103 communicates with a device (for example, an application server or a control server) existing on an external network (for example, the Internet, a cloud network, or a network unique to an operator) via a base station or an access point. Furthermore, for example, using the peer to peer (P2P) technology, the communication unit 103 communicates with a terminal (for example, a terminal of a pedestrian or a store, or an machine type communication (MTC) terminal) existing near the host vehicle. Moreover, for example, the communication unit 103 perform V2X communication such as vehicle-to-vehicle communication, vehicle-to-infrastructure communication, vehicle-to-home communication, vehicleto-pedestrian communication, and the like. Also, for example, the communication unit 103 includes a beacon receiving unit, receives radio waves or electromagnetic waves transmitted from radio stations provided on roads, and acquires information such as current location, traffic jam, traffic restriction, duration, or the like.

The movable body inner device 104 includes, for example, an information device carried in or attached to a mobile device, a wearable device, or a vehicle, a navigation device for searching for a route to a destination, and the like.

The output control unit 105 controls the output of various types of information. For example, the output control unit 105 generates an output signal including at least one of visual information (image data, for example) or auditory information (audio data, for example), and supplies the signal to the output unit 106 to control output of the visual information and auditory information from the output unit 106. More specifically, for example, the output control unit 105 combines image data captured by different imaging devices of the data acquisition unit 102, generates an overhead image or a panoramic image, and supplies an output signal including the generated image to the output unit 106. Furthermore, for example, the output control unit 105 generates voice data including a warning sound or a warning message for danger such as collision, contact, entering a danger zone, and the like, and outputs an output signal including the generated voice data to the output unit 106.

The output unit 106 includes a device capable of outputting visual information or auditory information to the outside of the vehicle. For example, the output unit 106 includes a display device, an instrument panel, an audio speaker, a projector, a lamp, and the like.

The drive system control unit 107 controls the drive system 108 by generating various control signals and supplying the signals to the drive system 108. In addition, the drive system control unit 107 supplies a control signal to each unit other than the drive system 108 as necessary, and provides notification of a control state of the drive system 108, and the like.

The drive system 108 includes various devices related to the drive system of the vehicle. For example, the drive system 108 includes a driving force generating device for generating driving force such as a driving motor, a driving force transmission mechanism for transmitting the driving force to the wheels, a steering mechanism for adjusting a steering angle, and a braking device for generating a braking force, an antilock brake system (ABS), an electronic stability control (ESC), an electric power steering device, and the like.

The storage unit 109 includes, for example, a read only memory (ROM), a random access memory (RAM), a magnetic storage device such as a hard disk drive (HDD), a semiconductor storage device, an optical storage device, a magneto-optical storage device, and the like. The storage unit 109 stores various programs, data, and the like used by each unit of the mobile device 100. For example, the storage unit 109 stores map data such as a three-dimensional high-precision map such as a dynamic map, a global map that covers a wide area with lower accuracy than a high-precision map, and a local map including information around the vehicle, and the like.

The autonomous movement control unit 110 performs control related to autonomous traveling. More specifically, for example, the autonomous movement control unit 110 perform a coordinate control aiming to realize an advanced driver assistance system (ADAS) function including collision avoidance or impact relaxation of the vehicle, following travel based on an inter-vehicular distance, vehicle speed maintaining travel, vehicular collision-warning, vehicular lane departure warning, or the like. The autonomous movement control unit 110 includes a detection unit 131, a self position estimation unit 132, a situation analysis unit 133, a planning unit 134, and an operation control unit 135.

The detection unit 131 detects various types of information necessary for control. The detection unit 131 includes a movable body external information detection unit 141, a movable body inner information detection unit 142, and a movable body state detection unit 143.

The movable body external information detection unit 141 performs a process for detecting information outside the vehicle on the basis of data or signals from each unit of the mobile device 100. For example, the movable body external information detection unit 141 performs a process for detecting an object around the vehicle, a recognition process, a tracking process, and a detection processing of the distance to the object. The object to be detected includes, for example, vehicles, people, obstacles, structural object, roads, traffic lights, traffic signs, road markings, and the like. Also, for example, the movable body external information detection unit 141 performs a process of detecting the environment around the movable body. The surrounding environment to be detected includes, for example, weather, temperature, humidity, brightness, road surface condition, and the like. The movable body external information detection unit 141 supplies data indicating the result of the detection process to the self position estimation unit 132, a map analysis unit 151 of the situation analysis unit 133, the situation recognition unit 152, a situation prediction unit 153, the operation control unit 135, and the like.

The movable body inner information detection unit 142 performs a process for detecting information in the movable body on the basis of the data or a signal from each unit of the mobile device 100. For example, the movable body inner information detection unit 142 performs a process for detecting environment in the movable body. The environment in the movable body to be detected includes, for example, temperature, humidity, brightness, odor, and the like. The movable body inner information detection unit 142 supplies data indicating the result of the detection process to the situation prediction unit 153 of the situation analysis unit 133, the operation control unit 135, and the like.

The movable body state detection unit 143 detects the state of the vehicle on the basis of data or a signal from each part of the mobile device 100. The state of the vehicle to be detected includes, for example, speed, acceleration, steering angle, presence/absence of abnormality and its contents, state of door lock, state of other in-vehicle devices, and the like. The movable body state detection unit 143 supplies data indicating the result of the detection process to the situation prediction unit 153 of the situation analysis unit 133, the operation control unit 135, and the like.

The self position estimation unit 132 detects the position and orientation of the vehicle on the basis of data or a signal from each part of the mobile device 100, such as the movable body external information detection unit 141 and the situation prediction unit 153 of the situation analysis unit 133. Furthermore, the self position estimation unit 132 generates a local map (hereinafter, referred to as a self position estimation map) used to estimate the self position, as necessary. The self-location estimation map is, for example, a high-accuracy map using a technique such as simultaneous localization and mapping (SLAM). The self position estimation unit 132 supplies data indicating the result of the estimation process to the map analysis unit 151, the situation recognition unit 152, the situation prediction unit 153, and the like of the situation analysis unit 133. Furthermore, the self position estimation unit 132 stores a self position estimation map in the storage unit 109.

The situation analysis unit 133 analyzes the situation of the vehicle and the surroundings. The situation analysis unit 133 includes the map analysis unit 151, the situation recognition unit 152, and the situation prediction unit 153.

The map analysis unit 151 analyzes various types of maps stored in the storage unit 109 by using data or signals from each unit of the mobile device 100 such as the self position estimation unit 132 and the movable body external information detection unit 141 according to need, and forms a map including information necessary for the move process. The map analysis unit 151 supplies the formed map to the situation recognition unit 152, the situation prediction unit 153, the route planning unit 161, the action planning unit 162, and the operation planning unit 163 in the planning unit 134, and the like.

The situation recognition unit 152 recognizes the situation around the vehicle on the basis of data or signals from each unit of the mobile device 100 such as the self position estimation unit 132, the movable body external information detection unit 141, the map analysis unit 151, and the like. By this recognition process, for example, the position and state of signals around the vehicle, the contents of traffic restriction around the vehicle, the travelable lane, and the like are recognized. The situation recognition unit 152 supplies data indicating the result of the recognition process to the situation prediction unit 153 and the like.

The situation recognition unit 152 performs the recognition process the situation regarding the vehicle on the basis of data or signals from each unit of the mobile device 100 such as the self position estimation unit 132, the movable body external information detection unit 141, the movable body inner information detection unit 142, the movable body state detection unit 143, the map analysis unit 151, and the like. For example, the situation prediction unit 153 performs the recognition process of the situation of the vehicle, the situation around the vehicle, and the like. In addition, the situation prediction unit 153 generates a local map (hereinafter referred to as a situation recognition map) used to recognize the situation around the vehicle, according to need. The situation recognition map is, for example, an occupancy grid map.

The situation of the vehicle to be recognized includes, for example, the position, posture, movement (for example, speed, acceleration, moving direction, etc.) of the vehicle, and the presence or absence and contents of abnormality. The situation around the vehicle to be recognized includes, for example, the type and position of the surrounding stationary object, the type, position and movement of the surrounding moving object (speed, acceleration, movement direction, or the like, for example), surrounding road configuration, and road surface conditions, as well as surrounding weather, temperature, humidity, brightness, and the like are included.

The situation prediction unit 153 supplies data indicating the result of the recognition process (including the situation recognition map as necessary) to the self position estimation unit 132 and the like. In addition, the situation prediction unit 153 stores the situation recognition map in the storage unit 109.

The situation prediction unit 153 predicts the situation regarding the vehicle on the basis of data or signals from each part of the mobile device 100 such as the map analysis unit 151, the situation recognition unit 152, and the like. For example, the situation prediction unit 153 performs prediction process of the situation of the vehicle, the situation around the vehicle, and the like.

The situation of the subject vehicle to be predicted includes, for example, behavior of the vehicle, an occurrence of an abnormality, a travelable distance, and the like. The situation around the vehicle to be predicted includes, for example, behavior of a moving object around the vehicle, a change in a signal state, and a change in environment such as weather, and the like.

The situation prediction unit 153 supplies data indicating the result of the prediction process to a route planning unit 161, an action planning unit 162, an operation planning unit 163, and the like of the planning unit 134 together with the data from the situation recognition unit 152.

The route planning unit 161 plans a route to a destination on the basis of data or signals from each unit of the mobile device 100 such as the map analysis unit 151, the situation prediction unit 153, and the like. For example, the route planning unit 161 sets a route from the current location to the specified destination on the basis of the global map. In addition, for example, the route planning unit 161 changes the route as appropriate on the basis of the traffic congestion, an accident, a traffic restriction, a situation such as a construction, and the like. The route planning unit 161 supplies data indicating the planned route to the action planning unit 162 and the like.

The action planning unit 162 plans actions of the vehicle to safely travel the route planned by the route planning unit 161 within a planned period of time on the basis of data or signals from each unit of the mobile device 100 such as the map analysis unit 151, the situation prediction unit 153, and the like. For example, the action planning unit 162 performs planning of start, stop, traveling direction (for example, forward, backward, left turn, right turn, direction change, and the like), a traveling lane, a traveling speed, and the like. The action planning unit 162 supplies data indicating the planned action of the host vehicle to the operation planning unit 163 or the like.

The operation planning unit 163 plans an action of the vehicle for realizing the action planned by the action planning unit 162 on the basis of data or signals from each unit of the mobile device 100 such as the map analysis unit 151, the situation prediction unit 153, and the like. For example, the operation planning unit 163 plans acceleration, deceleration, a traveling track, and the like. The operation planning unit 163 supplies data indicating the planned operation of the vehicle to the operation control unit 135.

The operation control unit 135 controls the operation of the mobile device 100.

### 6. Hardware Configuration Example of Another Device

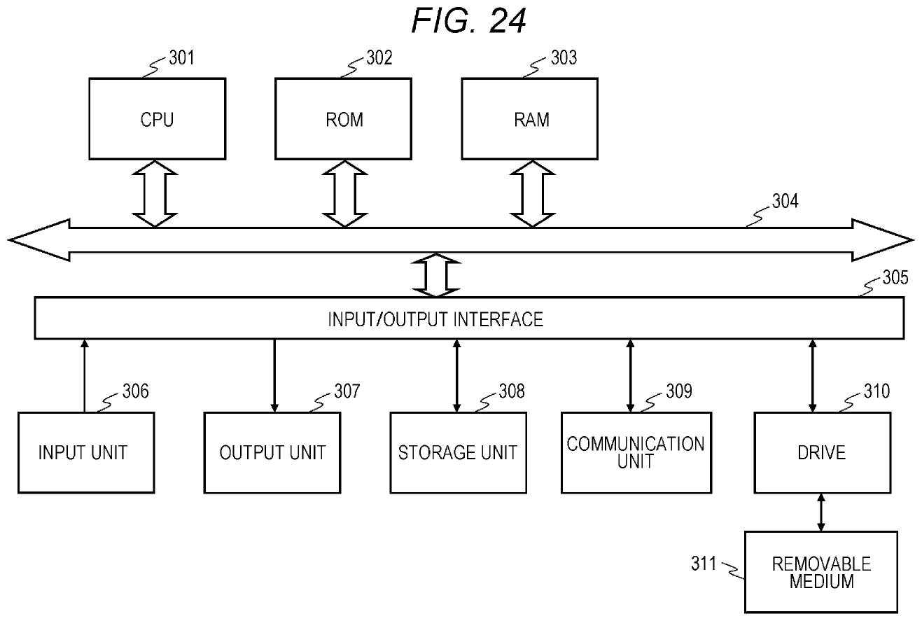

Next, a hardware configuration example of the management server 20 which is a device other than the mobile device 10 will be described with reference to FIG. 24.

A central processing unit (CPU) 301 functions as a data processing unit that executes various processes in accordance with a program stored in a read only memory (ROM) 302 or a storage unit 308. For example, processing according to the sequence described in the above-described embodiment is performed. The random access memory (RAM) 303 stores programs executed by the CPU 301, data, and the like. The CPU 301, the ROM 302, and the RAM 303 are mutually connected by a bus 304.

The CPU 301 is connected to an input/output interface 305 via the bus 304 and, to the input/output interface 305, an input unit 306 including various switches, a keyboard, a touch panel, a mouse, a microphone, and the like, and an output unit 307 including a display and a speaker are connected.

A storage unit 308 connected to the input/output interface 305 includes, for example, a hard disk and the like, and stores programs executed by the CPU 301 and various data. A communication unit 309 functions as a transmission/reception unit of data communication via a network such as the Internet or a local area network, and communicates with an external device.

A drive 310 connected to the input/output interface 305 drives a removable medium 311 such as a magnetic disk, an optical disk, a magneto-optical disk, or a semiconductor memory such as a memory card, and executes data recording or reading.

### 7. Summary of Configuration According to the Embodiments of the Present Disclosure

The embodiments of the present disclosure have been described in detail with reference to the specific embodiments. However, it is obvious that those skilled in the art can make modifications and substitutions of the embodiment without departing from the scope of the present disclosure. In other words, the present disclosure has been disclosed in a form of exemplification, and should not be construed in a limited manner. The scope of the present disclosure should be understood by referring to the claims.

Note that the technology disclosed in the present specification can have the following configurations.

(1) An information processing device including

a data processing unit including a processor in communication with a storage unit configured to store instructions that, when executed by the processor, cause the processor to:

determine data indicative of an estimation of whether or not there is a person in a residence for performing a delivery process, including determining the data based on external characteristic information of an outside of the residence.

(2) The information processing device according to (1), in which

the instructions further cause the processor to

determine the data indicative of the estimation based on at-home probability data which is calculated on a basis of the external characteristic information of the outside of the residence.

(3) The information processing device according to (2), in which

the at-home probability data includes

date-and-time related data which varies according to date and time, and

the instructions further cause the processor to calculate an at-home probability corresponding to a current date and time based on the at-home probability data.

(4) The information processing device according to (2) or (3), in which

the at-home probability data includes

first at-home probability data for a normal day, and

special-day unique data in which an associated at-home probability increases or decreases in comparison with the first at-home probability data for the normal day, and

the instructions further cause the processor to

select between the first at-home probability data for the normal day and the special-day unique data based on the current date and time.

(5) The information processing device according to any one of (2) to (4), in which

the instructions further cause the processor to

generate the at-home probability data by comparing information associated with a prescribed at-home estimation rule for estimating whether or not there is a person in the residence with the external characteristic information.

(6) The information processing device according to (5), in which the instructions further cause the processor to select the at-home estimation rule from a plurality of at-home estimation rules that each correspond to different residence types.

(7) The information processing device according to any one of (1) to (6), in which

the information processing device is

a mobile device capable of autonomous traveling, and

a sensor of the mobile device acquires the external characteristic information that can be observed from outside of the residence.

(8) The information processing device according to (7), in which the sensor includes a camera that captures an image.

(9) The information processing device according to (7) or (8), in which

the instructions further cause the processor to

perform a learning process to update at-home probability data on a basis of the external characteristic information acquired by the sensor.

(10) The information processing device according to any one of (1) to (9), in which

the instructions further cause the processor to

acquire a delivery result indicating whether or not a package delivery to the residence has succeeded,

associate the delivery result acquired by the delivery result acquisition unit and appearance characteristic information of the residence at time of delivery, and

generate at-home estimation data that classifies and records appearance characteristic information in a case where there is a person in the residence and appearance characteristic information in a case where no one is in the residence.

(11) The information processing device according to (10), in which

the instructions further cause the processor to

update at-home estimation data by executing a learning process according to: an input of new at-home information or absent information from the delivery result acquisition unit, or an input of new appearance characteristic information.

(12) The information processing device according to (10) or (11), in which the at-home estimation data includes different data corresponding to residence types.

(13) The information processing device according to any one of (1) to (12), wherein

the instructions further cause the processor to

determine a delivery route for a package destined to the residence based on the determined data.

(14) The information processing device according to any one of (1) to (13), in which

the instructions further cause the processor to

determine a delivery route of a package according to at-home probability of each of a plurality of residences.

(15) The information processing device according to (14), in which

the instructions further cause the processor to

determine the delivery route as giving priority to a residence having a higher at-home probability.

(16) The information processing device according to (14), in which
the instructions further cause the processor to
determine a delivery route of a plurality of packages according to the at-home probability of each of the plurality of residences, wherein the plurality of residences comprise destination residences for each of the plurality of packages.

(17) An information processing system including:

a mobile device; and

a management server, in which

a sensor of the mobile device acquires external characteristic information of outside of a residence and transmits the information to the management server, and

the management server includes a processor in communication with a storage unit configured to store instructions that, when executed by the processor, cause the processor to:

determine data indicative of an estimation of whether or not there is a person in the residence for performing a delivery process comprising determining the data based on the external characteristic information.

(18) The information processing system according to (17), in which

the instructions of the storage unit of the management server further cause the processor to

determine the data indicative of the estimation based on at-home probability data generated in advance.

(19) The information processing system according to (18), in which

the at-home probability data includes date-and-time related data which varies corresponding to date and time, and

the instructions of the storage unit of the management server further cause the processor to

calculate at-home probability corresponding to a current date and time based on the at-home probability data.

(20) The information processing system according to (17), wherein

the instructions of the storage unit of the management server further cause the processor to

determine a delivery route for a package destined to the residence based on the determined data.

(21) An information processing method executed in an information processing device including a data processing unit including a processor in communication with a storage unit configured to store instructions that, when executed by the processor, cause the processor to determine data indicative of an estimation of whether or not there is a person in a residence for performing a delivery process, the method including determining, by the data processing unit, the data based on external characteristic information of an outside of the residence.

(22) An information processing method executed in an information processing system including a mobile device and a management server, the method including:

acquiring, by a sensor of the mobile device, external characteristic information of an outside of a residence and transmitting the information to the management server,

determining, by the management server, data indicative of an estimation of whether or not there is a person in the residence for performing a delivery process comprising determining the data based on the external characteristic information.

(23) A non-transitory computer readable medium comprising instructions that, when executed by a processor, cause the processor to

determine data indicative of an estimation of whether or not there is a person in a residence for performing a delivery process comprising determining the data based on external characteristic information of an outside of the residence.

Note that the series of processes described in the specification can be performed by hardware, software, or a combination of both. In a case where the process is performed by software, the program recording the processing sequence is installed in a memory in a computer built into dedicated hardware and executed, or the program is installed and executed on a general-purpose computer capable of executing various processing. For example, the program can be recorded in a recording medium in advance. The program can be installed from a recording medium to a computer, or can be installed in a recording medium such as a built-in hard disk by receiving the program via a network such as a local area network (LAN) or the Internet.

In addition, the various processes described in the specification are not only to be executed chronologically according to the description, and may be executed in parallel or individually depending on the processing capability of the device that executes the process or as necessary. Furthermore, in the present specification, a system is a logical set configuration of a plurality of devices, and the devices of each configuration are not limited to those in a same housing.

It should be understood by those skilled in the art that various modifications, combinations, sub-combinations and alterations may occur depending on design requirements and other factors insofar as they are within the scope of the appended claims or the equivalents thereof.

### INDUSTRIAL APPLICABILITY

As described above, an embodiment of the present disclosure realizes a configuration that the sensor of the mobile device acquires external characteristic information that can be observed from outside of the residence, and at-home estimation of whether or not there is a person in the residence is performed.

More specifically, for example, a data processing unit is included to perform the at-home estimation of whether or not there is a person in the residence. The data processing unit performs the at-home estimation based on at-home probability data calculated on the basis of the external characteristic information that can be observed from outside of the residence. The at-home probability data is data that varies according to date and time, and the at-home probability corresponding to the current date and time is calculated from the at-home probability data. The data processing unit performs a process of comparing at-home estimation rules and external characteristic information, which differ according to residence types, to calculate the at-home probability. The information processing device is a mobile device capable of autonomous traveling, and a sensor of the mobile device acquires external characteristic information that can be observed from outside of the residence.

This configuration realizes a configuration that the sensor of the mobile device acquires external characteristic information that can be observed from outside of the residence and at-home estimation of whether or not there is a person in the residence is performed.

### REFERENCE SIGNS LIST

10 Mobile device
11 Package
20 Management server
51 Estimation data selection unit
52 Delivery result acquisition unit
53 At-home estimation unit (learning processing unit)
100 Mobile device
103 Communication unit
109 Storage unit
110 Autonomous movement control unit
112 Sensor group
113 Drive unit (Actuator group)
120 Data processing unit
121 Recognition processing unit (Sensor detection information analysis unit)
122 Action plan processing unit (Learning processing unit)
123 Action control processing unit
301 CPU
302 ROM
303 RAM
304 Bus
305 Input/output interface
306 Input unit
307 Output unit
308 Storage unit
309 Communication unit
310 Drive
311 Removable media

1. An information processing device comprising:
a data processing unit comprising a processor in communication with a storage unit configured to store instructions that, when executed by the processor, cause the processor to:
determine data indicative of an estimation of whether or not there is a person in a residence for performing a delivery process, comprising determining the data based on external characteristic information of an outside of the residence.

2. The information processing device according to claim 1, wherein
the instructions further cause the processor to
determine the data indicative of the estimation based on at-home probability data which is calculated on a basis of the external characteristic information of the outside of the residence.

3. The information processing device according to claim 2, wherein
the at-home probability data includes
date-and-time related data which varies according to date and time, and
the instructions further cause the processor to calculate an at-home probability corresponding to a current date and time based on the at-home probability data.

4. The information processing device according to claim 2, wherein
the at-home probability data includes
first at-home probability data for a normal day, and
special-day unique data in which an associated at-home probability increases or decreases in comparison with the first at-home probability data for the normal day, and
the instructions further cause the processor to
select between the first at-home probability data for the normal day and the special-day unique data based on the current date and time.

5. The information processing device according to claim 2, wherein
the instructions further cause the processor to
generate the at-home probability data by comparing information associated with a prescribed at-home estimation rule for estimating whether or not there is a person in the residence with the external characteristic information.

6. The information processing device according to claim 5, wherein the instructions further cause the processor to select the at-home estimation rule from a plurality of at-home estimation rules that each correspond to different residence types.

7. The information processing device according to claim 1, wherein
the information processing device is
a mobile device capable of autonomous traveling, and
a sensor of the mobile device acquires the external characteristic information that can be observed from the outside of the residence.

8. The information processing device according to claim 7, wherein the sensor includes a camera that captures an image.

9. The information processing device according to claim 7, wherein
the instructions further cause the processor to
perform a learning process to update at-home probability data on a basis of the external characteristic information acquired by the sensor.

10. The information processing device according to claim 1, wherein
the instructions further cause the processor to
acquire a delivery result indicating whether or not a package delivery to the residence has succeeded,
associate the delivery result acquired by the delivery result acquisition unit and appearance characteristic information of the residence at time of delivery, and
generate at-home estimation data that classifies and records appearance characteristic information in a case where there is a person in the residence and appearance characteristic information in a case where no one is in the residence.

11. The information processing device according to claim 10, wherein
the instructions further cause the processor to
update at-home estimation data by executing a learning process according to: an input of new at-home information or absent information from the delivery result acquisition unit, or an input of new appearance characteristic information.

12. The information processing device according to claim 10, wherein the at-home estimation data includes different data corresponding to residence types.

13. The information processing device according to claim 1, wherein
the instructions further cause the processor to
determine a delivery route for a package destined to the residence based on the determined data.

14. The information processing device according to claim 13, wherein
the instructions further cause the processor to
determine a delivery route of a package according to at-home probability of each of a plurality of residences.

15. The information processing device according to claim 14, wherein
the instructions further cause the processor to
determine the delivery route as giving priority to a residence having a higher at-home probability.

16. The information processing device according to claim 14, wherein
the instructions further cause the processor to
determine a delivery route of a plurality of packages according to the at-home probability of each of the plurality of residences, wherein the plurality of residences comprise destination residences for each of the plurality of packages.

17. An information processing system comprising:
a mobile device; and
a management server, wherein
a sensor of the mobile device acquires external characteristic information of an outside of a residence and transmits the information to the management server, and
the management server comprising a processor in communication with a storage unit configured to store instructions that, when executed by the processor, cause the processor to:
determine data indicative of an estimation of whether or not there is a person in the residence for performing a delivery process, comprising determining the data based on the external characteristic information.

18. The information processing system according to claim 17, wherein
the instructions of the storage unit of the management server further cause the processor to
determine the data indicative of the estimation based on at-home probability data generated in advance.

19. The information processing system according to claim 18, wherein
the at-home probability data includes date-and-time related data which varies corresponding to date and time, and
the instructions of the storage unit of the management server further cause the processor to
calculate at-home probability corresponding to a current date and time based on the at-home probability data.

20. The information processing system according to claim 17, wherein
the instructions of the storage unit of the management server further cause the processor to
determine a delivery route for a package destined to the residence based on the determined data.

21. An information processing method executed in an information processing device including a data processing unit comprising a processor in communication with a storage unit configured to store instructions that, when executed by the processor, cause the processor to determine data indicative of an estimation of whether or not there is a person in a residence for performing a delivery process, the method comprising
determining, by the data processing unit, the data based on external characteristic information of an outside of the residence.

22. An information processing method executed in an information processing system including a mobile device and a management server, the method comprising:
acquiring, by a sensor of the mobile device, external characteristic information of an outside of a residence and transmitting the information to the management server, and
determining, by the management server, data indicative of an estimation of whether or not there is a person in the residence for performing a delivery process, comprising determining the data based on the external characteristic information.

23. A non-transitory computer readable medium comprising instructions that, when executed by a processor, cause the processor to
determine data indicative of an estimation of whether or not there is a person in a residence for performing a delivery process, comprising determining the data based on external characteristic information of an outside of the residence.
